(19) United States
(12) Patent Application Publication
(10) Pub. No.: US 2025/0212924 A1
(43) Pub. Date: Jul. 3, 2025

(54) PLANT-ONLY GUMS (1) REPLACEMENT SYSTEM IN FOOD PRODUCTS

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/850,082

(22) PCT Filed: May 3, 2023
(86) PCT No.: PCT/IB2023/054597

§ 371 Date: Sep. 27, 2024

Related U.S. Application Data
(60) Provisional application No. 63/338,229, filed on May 4, 2022.

(51) Int. Cl. A23L 29/206; A23J 3/14; A23J 3/16; A23J 3/22; A23L 29/212; A23L 29/238

(52) U.S. Cl. CPC A23L 29/206; A23J 3/14; A23J 3/16; A23J 3/227; A23L 29/212; A23L 29/238

(57) ABSTRACT

The present disclosure discloses a plant-only composition for a food product. The plant-only composition comprises (i) about 5% to about 60% weight by weight of one or more polysaccharides sources, (ii) about 1% to about 30% weight by weight of one or more plant-derived mucilage, (iii) about 1% to about 30% weight by weight of one or more plant-derived protein, and (iv) about 1% to about 30% weight by weight of one or more plant-derived fiber mucilage. The plant-only composition substitutes a gum ingredient in the food product. The food product comprises processed cheese, soups, pastry ices, soft viscous candies, fruit-based and membrane-coated items, burgers, burger mixes, cakes, chocolate bars, pancake mixes, Traditional Burger Products, a baked good, a plant-only burger products, or another food product.

### CROSS-REFERENCE TO RELATED APPLICATIONS

This application claims priority to the U.S. provisional patent application No. 63/338,229, filed on May 4, 2022 and PCT provisional patent application no.: PCT/IB2023/054597, filed

on May 3, 2023, titled “PLANT-ONLY GUMS (1) REPLACEMENT SYSTEM IN FOOD PRODUCTS” and is incorporated herein by reference

### BACKGROUND

### Technical Field

The present disclosure relates to plant-only gum replacement system, replacing the chemical, synthetic and/or highly processed gum additives in commercially available food products such as animal-based or plant-based burgers, burger mixes, other meat-based products, meat alternative products, frozen food products, baked goods and other food products, including food product mixes in which the functionality of one or more gums may be desired to improve consistency of a food product. Such plant-only replacements are minimally processed and are free of synthetic food additives.

### Description of the Related Art

Many commercially available, processed plant-based and animal-based food products contain natural and/or synthetic food additives as well as other highly processed ingredients. The categories of commercially available food products containing such additives vary greatly, and include animal flesh-based (i.e., any one or more of beef, pork, poultry, fish, shellfish, other seafood, etc.) or imitation meat-containing products based in whole or in part on plant-derived materials, or food products comprised of a combination both animal-source and plant-sourced materials. As an example, these food products may be, in one form, commercially available burgers and burger mixes, patties, cakes, crumbles, etc. Additives are found in all types of commercially available food products, and serve as stabilizers, preservatives, colorants, flavor enhancers, sweeteners, thickeners, texturizers, and emulsifiers, and provide a variety of desired characteristics such as flavors, textures, appearance, and consistency. Additives can maximize yield, minimize shrinkage and cooking loss, and/or lead to more uniform blending or homogeneity to the food product or food product mix.

Together, all of the meat-based and/or plant-based meat alternative food products available commercially in any form will be referred to as “Traditional Burger Products,” despite their origin or form. These are distinguished from the plant-only burgers and burger mixes, collectively, plant-only “burger products,” as well as the plant-only gum replacement system of the disclosed embodiments. These terms are discussed in more detail and the categories distinguished further below.

Commercially available, traditional Burger Products are generally highly processed foods. Traditional, meat-based burgers contain meat or animal flesh of some kind, added saturated fats, bone (carcass), highly processed ingredients, synthetic additives and other ingredients that may be inappropriate for certain diets, e.g., vegetarian, vegan, salt-restricted, low-fat, low saturated fat, culturally- or religiously-restricted diets etc. Even some commercially available “plant-based,” “plant-derived,” “meatless,” and “meat-free” burgers and other food products (depending on how those terms are defined by the manufacturers, or under definitions supported by a governmental authority in the location of manufacture) may contain animal-derived ingredients such as bone and meat broth or gelatin, dairy products and certain saturated fats, sourced from animals slaughtered for food, or from animals raised primarily for dairy product production. Such animal-derived additions can render even these “plant-based” burgers and burger mixes inappropriate for vegetarians and vegans.

Some meat substitutes have been developed, in part, to mimic the qualities that some consumers of plant-based alternatives desire in a burger: a juicy center, red color and meaty (or umami) taste but often a significant amount of saturated fat must be added to achieve a desired consistency or texture. Food additives in Traditional Burger Products may have physiological effects and many consumers do not want or do not want to risk if a healthier, more sustainable alternative is available that does not pose the downsides. Examples of food additives commonly found in Traditional Burger Products include silicon dioxide, sodium benzoate, sodium nitrite, and artificial food colors. Many such additives (particularly synthetic additives) can be harmful to consumers if consumed over prolonged periods. The food industry uses more than 7,000 synthetic and ultra-processed additives even though nature offers more than ten million compounds from more than 450,000 plants.

Gums (hydrocolloids) are additives and are commonly used to bind ingredients together, emulsify, stabilize, help retain moisture and thicken, modifying the textural and structural properties of the food products in which they are used. Gums commonly used as additives in the food industry include, among others, carrageenan gum, which helps retain moisture in a food product, gum arabica, which increases moisture retention, guar gum, which improves cooking yield and consistency and acts as a binding agent, and xanthan gum, which also improves cooking yield. Konjac gum and starches are also commonly used. When gums come into contact with water, they form a gel; they modulate the thickening, emulsifying, smoothing, and gelling properties of aqueous foods. Gums traditionally used in meat-based burgers include those listed above, as well as gum tragacanth, gum from Detarium mirocanepum and gum from Mucuna flagellipes. Gums traditionally used in so-called plant-based burgers include (in addition to guar gum and carrageenan gum), gellan gum (thickener, binder and stabilizer), locust bean gum (structure, firmness, and heat stability), acacia and oat gums (texturizer, emulsifier and stabilizer), mucilaginous gum/flax gel (moisture retention, binding), and methylcellulose (binding, improvement of consistency, texturizer).

It would be desirable to provide solely plant- or fungi-derived (hereafter, “plant-only,” as further defined below) ingredients that replace highly processed, synthetic, artificial and/or animal-derived (i.e., sourced directly or indirectly from an animal) gums found in meats and meat substitutes such as Traditional Burger Products, as well as in breads and other baked goods. A “plant-only” food product is free from dairy and other animal-derived ingredients and is minimally processed, with—or, as a component of another food product, contributing to a desirable flavor, taste, texture, homogeneity, consistency, color and appearance so as to be aesthetically pleasing prior to consumers.

Thus, there is a need for a plant-only composition for a food product to substitute a gum ingredient in the food product.

### SUMMARY

In view of the foregoing, embodiments herein provide a plant-only composition for a food product. The plant-only composition comprises (i) about 5% to about 60% weight by weight of one or more polysaccharides sources, (ii) about 1% to about 30% weight by weight of one or more plant-derived mucilage, (iii) about 1% to about 30% weight by weight of one or more plant-derived protein, and (iv) about 1% to about 30% weight by weight of one or more plant-derived fiber mucilage. The plant-only composition substitutes a gum ingredient in the food product.

In some embodiments, the one or more polysaccharides sources comprises at least one of almond polysaccharides, oat flour, quinoa flour, cassava flour, sunflower seeds flour, palm kernel meal, coconut flour, soya bean hulls, sugar beet pulp, pecan flour, cashew flour, macadamia flour, or a combination thereof. In some embodiments, the almond polysaccharides comprises (i) about 92.36% of polysaccharides comprising about 46.83% of arabinose, about 35.49% of galactose, and 5.97% of uronic acid, and (ii) about 2.45% of protein. The almond polysaccharides acts as a stabilizer, and an emulsifier in the food product as it stabilize the emulsion to form structured films. In some embodiments, the one or more polysaccharides sources present in the plant-only composition ranges from about 20% to about 40% weight by weight of the composition.

In some embodiments, the one or more polysaccharides sources present in the plant-only composition ranges from (i) about 5% to about 10% weight by weight of the composition, (ii) about 10% to about 20% weight by weight of the composition, (iii) about 20% to about 30% weight by weight of the composition, (iv) about 30% to about 40% weight by weight of the composition, (v) about 40% to about 50% weight by weight of the composition, or (vi) about 50% to about 60% weight by weight of the composition.

In some embodiments, the one or more polysaccharides sources has a polysaccharides content of about 20% to about 92.36%, a swelling index ranging from 22.27% to 87.75%, and an emulsion stability of about 45.83% to about 92.6%, a pH of about 3.9 to about 4.4, moisture content of about 12.5% to about 15.0%, bulk density of about 0.6 gram per milliliter (g/ml), and a porosity of about 42.06%.

In some embodiments, the one or more plant-derived mucilage comprises at least one of quince seed mucilage, sweet basil seed mucilage, chia seed mucilage, yellow mustard mucilage, moringa seeds mucilage, fenugreek seeds mucilage, Cordia dichotoma seeds mucilage, arugula seeds mucilage, radish seeds mucilage, cress seeds mucilage, okra mucilage, or a combination thereof. In some embodiments, the quince seed mucilage comprises glucuronic acid and xylose that forms glucuronoxylan polysaccharide hydrogel which has increased swelling power. The quince seed mucilage comprises about 2.2% protein that affects the interfacial tension at the oil-water interface which directly affects its emulsification stability.

In some embodiments, one or more plant-derived mucilage present in the plant-only composition ranges from about 10% to about 20% weight by weight of the composition. In some embodiments, the one or more plant-derived mucilage present in the plant-only composition ranges from (i) about 1% to about 5% weight by weight of the composition, (ii) about 5% to about 10% weight by weight of the composition, (iii) about 5% to about 20% weight by weight of the composition, (iv) about 10% to about 15% weight by weight of the composition, (v) about 15% to about 20% weight by weight of the composition, (v) about 20% to about 25% weight by weight of the composition, or (vi) about 25% to about 30% weight by weight of the composition.

In some embodiments, the one or more plant-derived mucilage has a viscosity of about 1000 millipascal seconds at a shear rate of 46.16 inverse second (s⁻¹), a water holding capacity of about 10.27 grams water per gram (g/g) to about 94.13 g/g, an emulsion stability of about 35% to about 94.89%, a moisture content of about 5.8%, a viscosity of about 1473.96 millipascal seconds at shear rate of about 46.16 inverse second, a zeta potential measurement of greater than 30 millivolt (mV), and a foam stability of about 21.36%.

In some embodiments, the one or more plant-derived protein comprises at least one of mesquite protein, pea protein, lupine, mushrooms, quinoa, chickpeas protein, soy protein, pigeon pea, mung bean protein, peanut, pinto beans, oats, cow pea protein, or a combination thereof. In some embodiments, the mesquite protein comprises about 68% of protein, D-galactose, L-arabinose, D-glucuronate, D-mannose and D-xylose, The mesquite protein comprises galactomannans polysaccharide that act as a stabilizing and emulsifying agent in food products. The mesquite protein enables the formation and stabilization of emulsions in the presence of polysaccharides and has a shear thickening behaviour.

In some embodiments, the one or more plant-derived protein present in the plant-only composition ranges from about 5% to about 20% weight by weight of the composition. In some embodiments, the one or more plant-derived protein present in the plant-only composition ranges from (i) about 1% to about 5% weight by weight of the composition, (ii) about 5% to about 10% weight by weight of the composition, (iii) about 5% to about 20% weight by weight of the composition, (iv) about 10% to about 15% weight by weight of the composition, (v) about 15% to about 20% weight by weight of the composition, (vi) about 20% to about 25% weight by weight of the composition, or (v) about 25% to about 30% weight by weight of the composition.

In some embodiments, the one or more plant-derived protein has a molecular weight of about 10 to 50 kilodaltons (kDa), a water holding capacity of about 100% to 600%, an emulsion stability of about 35% to about 90%, a pH of about 4.38, moisture content of about 9.7% to 10.2%, and a molecular weight of about 484,000 gram per molar (g/mol).

In some embodiments, the one or more plant-derived fiber mucilage comprises at least one of linseed mucilage, Plantago psyllium mucilage, Plantago ovata seeds mucilage, chia seeds mucilage, mucilages of mangosteen, assyrian plum, prickly pear, cassava, Indian jujube fruit, coromandel ebony, orange fiber, tilkor fruit, or a combination thereof.

In some embodiments, the linseed mucilage comprises fiber, omega-3 and -6 fatty acids, and phenolic compounds and has arabinoxylans, which are non-starch polysaccharides, wherein the linseed mucilage increases protein and fat content, and decreases moisture in raw meat burgers, and further reduces fat absorption in frying. In some embodiments, the one or more plant-derived fiber mucilage present in the plant-only composition ranges from about 5% to about 20% weight by weight of the composition.

In some embodiments, the one or more plant-derived fiber mucilage present in the plant-only composition ranges from (i) about 1% to about 5% weight by weight of the composition, (ii) about 5% to about 10% weight by weight of the composition, (iii) about 5% to about 20% weight by weight of the composition, (iv) about 10% to about 15% weight by weight of the composition, (v) about 15% to about 20% weight by weight of the composition, (vi) about 20% to about 25% weight by weight of the composition, or (vii) about 25% to about 30% weight by weight of the composition. In some embodiments, the one or more plant-derived fiber mucilage has a water holding capacity of about 2.57 to about 28.66 grams water per gram (g water/g), an emulsion stability of about 42.22% to 70%, and a polyunsaturated fatty acids (PUFA)/saturated fatty acids (SFA) ratio of about 7.40.

In some embodiments, the food product comprises processed cheese, soups, pastry ices, soft viscous candies, fruit-based and membrane-coated items, burgers, burger mixes, cakes, chocolate bars, pancake mixes, Traditional Burger Products, a baked good, a plant-only burger products, or another food product.

In some embodiments, the plant-only composition comprises (i) about 20% to about 40% weight by weight of one or more polysaccharides sources, (ii) about 10% to about 20% weight by weight of one or more plant-derived mucilage, (iii) about 5% to about 20% weight by weight of one or more plant-derived protein, and (iv) about 5% to about 20% weight by weight of one or more plant-derived fiber mucilage. The plant-only composition substitutes a gum ingredient in the food product.

In some embodiments, the plant-only composition comprises (i) about 20% to about 40% weight by weight of almond polysaccharides, (ii) about 10% to about 20% weight by weight of quince seed mucilage, (iii) about 5% to about 20% weight by weight of mesquite protein, and (iv) about 5% to about 20% weight by weight of linseed mucilage. The plant-only composition substitutes a gum ingredient in the food product.

In some embodiments, the plant-only composition present in the food product ranges from about 0.5% to 3% weight by weight of the food product. In some embodiments, the plant-only composition present in the food product ranges from about 0.05% to about 10% weight by weight of the food product depending on the moisture content of the plant-only composition and that of the final food product. In some embodiments, the plant-only composition present in the food product ranges from about 0.05% to about 25% weight by weight of the food product.

In one aspect, a food product is provided. The food product comprises about 10% to about 15% weight by weight a plant-only composition. The plant-only composition comprises (i) about 20% to about 40% weight by weight of one or more polysaccharides sources, (ii) about 10% to about 20% weight by weight of one or more plant-derived mucilage, (iii) about 5% to about 20% weight by weight of one or more plant-derived protein, and (iv) about 5% to about 20% weight by weight of one or more plant-derived fiber mucilage. The plant-only composition substitutes a gum ingredient in the food product.

In some embodiments, the food product comprises (i) about 10% to about 20% weight by weight of one or more protein sources, (ii) about 5% to about 10% weight by weight of a plant-derived methyl cellulose replacement composition, (iii) about 10% to about 15% weight by weight of one or more plant-derived modified starches, (iv) about 10% to about 12% weight by weight of one or more plant-derived oils, and (v) about 0.5% to about 1% weight by weight of a plant-derived leavener replacement composition.

In some embodiments, the food product comprises (i) about 1% to about 2% weight by weight of one or more plant-derived shelf life extenders, (ii) about 0.5% to about 2% weight by weight of a plant-derived umami flavor, (iii) about 0.5% to about 1% weight by weight of one or more plant-derived flavorants/flavor enhancers, or nutraceuticals, (iv) about 1% to about 2% weight by weight of a second plant-derived flavor enhancer, (v) about 0.5% to about 2% weight by weight of one or more mineral salts, (vi) about 5% to about 10% weight by weight of one or more plant-derived binding agents, (vii) about 1% to about 2% weight by weight of one or more plant-derived leghemoglobin sources, and (viii) about 0.5% to about 2% weight by weight of one or more plant-derived lipid peroxidation inhibitors.

In some embodiments, the one or more protein sources comprises at least one of pea, mushroom, quinoa, chickpeas, or a combination thereof.

In some embodiments, the plant-derived methyl cellulose replacement composition comprises at least one of proteins, fibers from whole grains, fruits, seeds, vegetables, starches, vegetable binders, or a combination thereof.

In some embodiments, the one or more plant-derived oils comprises at least one of sunflower oil, coconut oil, flaxseed oil, rice bran oil, other oil comprising at least one of Omega-3 fatty acids, Monounsaturated fatty acids (MUFA), or Medium-chain triglycerides (MCTs), or a combination thereof.

In some embodiments, the one or more plant-derived modified starches comprises at least one of tapioca starch, faba bean starch, sorghum starch, quinoa starch, or a combination thereof.

In some embodiments, the plant-derived leavener replacement composition comprises at least one of plant-derived fibers, fruit pectins, fruit acids, plant-derived starches, cereal sources, or a combination thereof.

In some embodiments, the plant-derived leavener replacement composition comprises at least one of plum powder, apple cider vinegar, vegan buttermilk, or a combination thereof.

In some embodiments, the one or more plant-derived shelf life extenders comprises at least one of garlic, black pepper, oregano, bay laurel, or a combination thereof. The plant-derived umami flavor comprises at least one of shitake and other mushrooms, tomatoes, garlic, lotus stalk, onions, salt, or a combination thereof. The one or more plant-derived flavorants/flavor enhancers, or nutraceuticals comprises at least one of cumin, coriander, paprika, black pepper, or a combination thereof. The plant-derived enhancer comprises at least one of nutritional yeast, cashew nuts, or a combination thereof. The one or more mineral salts comprises at least one of Himalayan pink salt, sea salt, or a combination thereof. The one or more plant-derived binding agents comprises at least one of chickpeas, oat fiber, aquafaba, sugar beet pectin, or a combination thereof. The one or more plant-derived leghemoglobin sources comprises at least one of beets, soy, red radish, or a combination thereof. The one or more plant-derived lipid peroxidation inhibitors comprises at least one of black pepper, bay leaf, cumin, or a combination thereof.

In another aspect, a plant-only gum replacement system for a food product comprising a plant-only composition is provided. The plant-only composition comprises (i) about 5% to about 60% weight by weight of one or more polysaccharides sources, (ii) about 1% to about 30% weight by weight of one or more plant-derived mucilage, (iii) about 1% to about 30% weight by weight of one or more plant-derived protein, and (iv) about 1% to about 30% weight by weight of one or more plant-derived fiber mucilage. The plant-only composition substitutes a gum ingredient in the food product.

The plant-only composition can be used as an alternative/substitute for gum ingredient in the food products, for example, processed cheese, soups, pastry ices, soft viscous candies, fruit-based and membrane-coated items, burgers, burger mixes, cakes, chocolate bars, pancake mixes, traditional burger products, a baked good, a plant-only burger products, or another food product. The plant-only composition replaces conventional gum ingredients in food products that consists of minimally processed, plant-derived ingredients while ensuring desirable flavor, texture, appearance and taste as well as the same or similar functionality of conventional gum ingredients for the food product to which the composition is incorporated.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications. Further, one skilled in the relevant art will recognize that the embodiments can be practiced without one or more of the specific details or with other methods, components, materials and so forth. In other instances, well-known structures, materials, or operations are not shown in detail to avoid obscuring the features of the embodiments. Furthermore, the features/aspects described can be practiced in various combinations, though only some of the combinations are described herein for conciseness.

### BRIEF DESCRIPTION OF THE DRAWINGS

The embodiments herein will be better understood from the following detailed description with reference to the drawings, in which.

FIG. 1 illustrates a plant-only composition for a food product according to some embodiments herein; and

FIG. 2 illustrates a flow diagram of a process of preparing a plant-only composition for a food product according to some embodiments herein.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

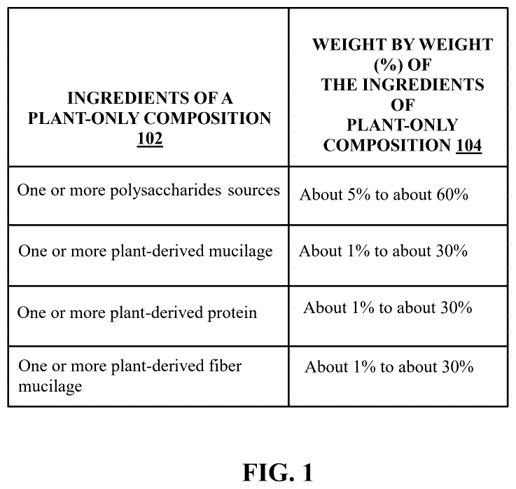

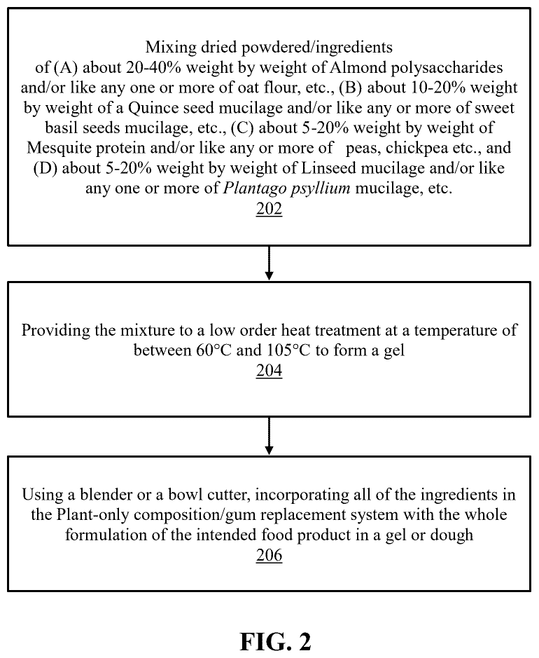

Referring now to the drawings, and more particularly to FIGS. 1 through 2, where similar reference characters denote corresponding features consistently throughout the figures, there are shown preferred embodiments.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The terms “comprising”, “comprises” and “comprised of” as used herein are synonymous with “including”, “includes” or “containing”, “contains”, and are inclusive or open-ended and do not exclude additional, non-recited members, elements or method steps.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

Aspects of the disclosure are provided herein for a plant-only gum replacement system/plant-only composition and components thereof to be used in place of commercially available synthetic or processed gums in a variety of food products. The selection of plant-derived ingredients and combinations of ingredients selected by the Charaka machine learning system provide effective functionalities for gums in food products, including meat substitutes. Commercially available, meat-based and/or imitation meat based food products such as highly processed plant-based, plant-derived, meatless or meat-free burgers, burger mixes and other types of imitation meats and meat-alterative products (together, “Traditional Burger Products”) are one category of food products that can benefit from substitution of commercially utilized gums for plant-derived, non-synthetic ingredients and additives that are minimally processed. In the disclosed embodiments of the gum replacement system, plant-derived ingredients effectively function as texturizing agents and volume enhancers in food products, replacing the conventional, non-plant-derived, synthetic or highly processed additives and ingredients normally found in Traditional Burger Products and other commercially available food products. In the disclosed embodiments, plant-only food additive replacements (or replacement systems) are comprised of only minimally processed, naturally occurring (i.e., non-synthetic) ingredients sourced solely sources outside of the animal kingdom, e.g., from plants, fungi, or algae.

Embodiments disclosed herein include the plant-only gum replacement system (category 1), or components of it, for replacing various gums traditionally found in commercially available food products, including Traditional Burger Products. In some embodiments, the gum replacement system or aspects of the system may replace part of the meat or fibrous material as well as the additives of a (meat-based or plant-derived) Traditional Burger Product. In other embodiments, the gum replacement system or components of it complement the ingredients of plant-based or plant-derived Traditional Burger Products, by providing more plant-only sources that enhance the nutritional or aesthetic value (e.g., flavor) of the food product. In still other embodiments, the gum replacement system's plant-derived ingredients may replace any-even partially-animal-derived ingredients of, so-called “plant-derived,” “plant-based” or meatless, imitation meat food products, including food product mixes. In some embodiments, the gum replacement system may be a standalone, consumable food product. In other embodiments, the replacement system is a food product may be mixed with one or more ingredients or other components of another consumable food product.

The disclosed plant-only gum replacement system (as a food product itself, or for inclusion in other food products) relates to non-synthetic, unprocessed or minimally processed, substitute ingredients for the gums commonly used in commercially available food products. Specifically, the gum substitutes in the replacement system embodiments disclosed herein (category 1) are stabilizers and binding agents that reduce cooking loss, and improve a food product's consistency and structure. Other gum replacement systems comprise gum substitutes that texturize and thicken, bind, emulsify and stabilize (category 2); and those that help a food product retain moisture, improving binding and cooking yield (category 3); each of these is the subject of a separate disclosure. The focus of this disclosure is category 1 plant-only composition/gum replacement system, which may be used, in some embodiments, alone or, in other embodiments, in combination with either category 2, or category 3 gum replacement systems in the same food product(s).

“Plant-only” products disclosed herein, as opposed to products labeled as “plant-derived,” “plant-based,” “meatless,” “meat-free” and the like, refer to food products whose ingredients, apart from any significant amount of water added, are derived solely from sources outside of the animal kingdom, e.g., from plants, fungi, or algae. That is, “plant-only” may refer to any composition, formulation, system, agent, ingredient, or component of a food product, or the entire food product itself, that is produced, developed, or otherwise obtained directly or indirectly from one or more plants or fungi, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from animals. The US Food and Drug Administration currently has no accepted standard definition for labeling of food products described as “plant-based” although a private trade organization, the Plant Based Food Association, has proposed voluntary standards to ensure consistency when the term “plant-based” is used on a product label (i.e., it contains no animal-sourced content), and seeks to certify-through its own certification process-food products, including food product mixes, that meet this standard. See https://www.plantbasedfoods.org/policy/labeling/. The terminology used on a label for a plant-based food must be truthful under FDA regulations; however, in the US, no regulatory body currently requires a company to refrain from including some amount of meat, seafood, or other animal-sourced ingredients in a “plant-based” product.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. The plant-only composition disclosed herein in certain embodiments may be incorporated into or used with meat-based food products; in other embodiments it may be incorporated into or used with seafood-based food products; in still other embodiments, it may be incorporated into or used with plant-based food products. In certain preferred embodiments, the plant-only composition may be incorporated into or used with plant-only food products, including Traditional Burger Products or for providing gum-like functionality in plant-only burger products and other food products.

In certain embodiments, while some of the water content of a food product may be derived from a plant source, water may also be added to the product from an external source. For example, in scenarios in which a plant-only agent or system or plant-only food product is in the form of a gel or liquid, it is further understood that water can be included as solvent or liquid carrier for the plant-only system, ingredient or food product, where any amount of water (some or all) within the system, ingredient or food product may or may not be derived from a plant source. In some embodiments, water may be added from an external source as part of the plant-only gum replacement system (or any other plant-only replacement system referenced herein). In other embodiments the plant-only gum replacement system may be available in a dried form; in certain embodiments the dried form may be powdered; in other embodiments, the dried form of the gum replacement system may be in a partially powdered form; in other embodiments it may be available in a semi-liquid or gel form; in other embodiments it may be in a liquid or frozen form.

In the disclosed embodiments, apart from externally-sourced water, the plant-derived food product consists entirely of ingredients derived from members of the plant or fungi kingdoms, excluding any component or ingredient that is: (i) dairy-based or otherwise derived from any member of the animal kingdom; and (ii) more than minimally processed; and (ii) synthetic. In some embodiments, the plant-only gum replacement system, or components thereof, replace conventional ingredients and additives found in meat-based food products such as commercially available meat-based burgers. In other embodiments, the gum replacement system replaces those additives found in commercially available plant-based, plant-derived, meatless, meat-free food products that range from burgers and burger mixes to baked goods and frozen food products.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, e.g., a food item from a member of the plant or fungi kingdoms that comprises one or more naturally occurring chemical compounds. Selection of specific plant-derived ingredients, or specific combinations of plant-only or plant-derived ingredients, provide effective functionalities for gum replacement additives in a food product (e.g., a plant-only food product). As used herein, the term “component” or “ingredient” refers to a particular item that includes one or more chemical compounds (e.g., a food/edible parts from the plant species that comprises one or more naturally occurring chemical compounds).

In example embodiments, the plant-only food product includes a combination of components or ingredients from the plant genus that render the combination (in the amounts as indicated) particularly suitable as a gum replacement agent or composition for a food product. In such embodiments, the plant-only gum replacement system is added to other food ingredients to form a final food product formulation that requires such gum replacement composition/system. Examples of food products that utilize gum replacement additives include, without limitation, dessert like products such as Traditional Burger Products or for providing gum-like functionality in plant-only burger products and other food products.

### Charaka Machine Learning (ML) Platform and Ayurvedic System

In general, the selection of a specific combination of ingredients for plant-only products/composition/system is determined using a proprietary machine learning (ML) platform, which blends ancestral wisdoms of plant nutrition with biotechnology and ML to analyze members of the plant and fungi kingdoms and from plants and fungi, the compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.). Ayurvedic and/or other holistic properties, physicochemical properties (e.g., pH, viscosity, moisture content, density, etc.), mechanical properties (e.g., adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-derived ingredients is determined to yield an effective gum replacement formulation that can be used to forming a desirable food product or formulation that is effective as a substitute for conventional ingredients in Traditional Burger Products or for providing gum-like functionality in plant-only burger products and other food products.

As noted, the proprietary system identifies natural alternatives, i.e., plant-only alternatives to synthetic, artificial, and animal-derived products, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self—one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). The information recommended by the proprietary Charaka system permits one to choose between hundreds of alternatives based on ingredients intended to alter a variety of properties to give optimal results for physiological functionality, health, and environmental sustainability.

A food product as described herein that functions to replace gums in Traditional Burger Products or plant-only burger products comprises a combination of solely plant- or fungi-sourced ingredients and added water, if any is required for gum preparation. The plant-derived ingredients and combinations of ingredients selected for the gum replacement system are consistent with the requirements and specifications of achieving the functionalities exhibited by conventionally used gums, when used in commercially available food products containing meat substitutes.

### Terms and Definitions

As used in the present invention, the following terms are generally intended to have the meaning as set forth below, except to the extent that the context in which they are used indicate otherwise.

Gums: Gums, or hydrocolloids, are hydrophilic, non-starchy carbohydrate polymers. They are used in food and bakery products as viscosity enhancers and gelling agents and to impart desirable textural and sensory properties.

Protein: Proteins are large biomolecules and macromolecules that comprise one or more long chains of amino acid residues.

Gel: A gel is a semi-solid that can have properties ranging from soft and weak to hard and tough. Gels are defined as a substantially dilute cross-linked system, which exhibits no flow when in the steady-state, although the liquid phase may still diffuse through this system.

Thickener: Thickener refers to a substance which can increase the viscosity of a liquid without substantially changing its other properties.

Emulsifier: Emulsifier is an additive that enables the suspension of one liquid in another.

Emulsion stability: Emulsion stability can be defined as the system's ability to resist changes in its physicochemical properties over time in applications such as food industry.

Foam stability: Foam stability is measured as the time required to lose either 50% of the liquid or 50% of the volume from the foam.

Gelling Agent: Gelling Agent refers to a gel-forming agent (e.g., hydrocolloids) which, when dissolved in a liquid phase as a colloidal mixture, forms a weakly cohesive internal structure.

Swelling Power: Swelling Power refers to water holding capacity of gums, which has generally been used to demonstrate differences between various types of starches.

Gelatinization temperature: Gelatinization temperature is a temperature at which the gelatinization is complete.

Pasting temperature: Pasting temperature is a temperature at which the viscosity begins to increase during the heating process.

Moisture content: Moisture content refers to a quantity of water contained in a material/substance.

Bulk Density: Bulk density is a weight of a volume unit of powder and is usually expressed in g/cm3, kg/m3, or g/100 ml.

Texturizing/Texturing agent: Texturing agent refers to additives that adds or modifies the overall texture or mouthfeel of food products.

Binding agent: Binding agent refers to food binders that are mixed in with other ingredients to help the food product to keep their shape and texture.

Water holding capacity (WHC): Water-holding capacity (or water-binding capacity, or water-absorption capacity) is a measure of the total amount of water that can be absorbed per gram of a powder/composition/ingredient.

Viscosity: Viscosity is the resistance of a fluid (e.g., liquid or gas) to a change in shape or movement of neighbouring portions relative to one another. Viscosity denotes opposition to flow.

Stabilization: Stabilization refers to a process of making composition/food product physically more secure or stable.

pH: pH is a measure of the hydrogen ion concentration in solution and is also referred to as the degree of acidity or alkalinity.

Plant-derived: “Plant-derived” refers to ingredients extracted from a plant.

Flavorant/Flavor enhancer: Flavorant is a food additive that is used to improve the taste or smell of food products.

Nutraceuticals: Nutraceuticals are products derived from food sources that provide both nutrition and medicinal benefits.

Animal-based food products: Animal-based food products refers to food products derived from animals include meat and meat products, poultry products (meat and eggs), fish, shellfish, dairy products (milk and cheese).

Embodiments herein provide a plant-only composition for a food product. The plant-only composition comprises (i) about 5% to about 60% weight by weight of one or more polysaccharides sources, (ii) about 1% to about 30% weight by weight of one or more plant-derived mucilage, (iii) about 1% to about 30% weight by weight of one or more plant-derived protein, and (iv) about 1% to about 30% weight by weight of one or more plant-derived fiber mucilage. The plant-only composition substitutes a gum ingredient in the food product.

In some embodiments, the plant-only composition comprises (i) about 20% to about 40% weight by weight of one or more polysaccharides sources, (ii) about 10% to about 20% weight by weight of one or more plant-derived mucilage, (iii) about 5% to about 20% weight by weight of one or more plant-derived protein, and (iv) about 5% to about 20% weight by weight of one or more plant-derived fiber mucilage. The plant-only composition substitutes a gum ingredient in the food product.

In one aspect, a food product is provided. The food product comprises about 10% to about 15% weight by weight a plant-only composition. The plant-only composition comprises (i) about 20% to about 40% weight by weight of one or more polysaccharides sources, (ii) about 10% to about 20% weight by weight of one or more plant-derived mucilage, (iii) about 5% to about 20% weight by weight of one or more plant-derived protein, and (iv) about 5% to about 20% weight by weight of one or more plant-derived fiber mucilage. The plant-only composition substitutes a gum ingredient in the food product.

In another aspect, a plant-only gum replacement system for a food product comprising a plant-only composition is provided. The plant-only composition comprises (i) about 5% to about 60% weight by weight of one or more polysaccharides sources, (ii) about 1% to about 30% weight by weight of one or more plant-derived mucilage, (iii) about 1% to about 30% weight by weight of one or more plant-derived protein, and (iv) about 1% to about 30% weight by weight of one or more plant-derived fiber mucilage. The plant-only composition substitutes a gum ingredient in the food product.

FIG. 1 illustrates a plant-only composition for a food product according to some embodiments herein. FIG. 1 depicts a table that includes ingredients 102 of the plant-only composition and weight 104 of the ingredients 102 of the plant-only composition. The plant-only composition comprises (i) about 5% to about 60% weight by weight of one or more polysaccharides sources, (ii) about 1% to about 30% weight by weight of one or more plant-derived mucilage, (iii) about 1% to about 30% weight by weight of one or more plant-derived protein, and (iv) about 1% to about 30% weight by weight of one or more plant-derived fiber mucilage. The plant-only composition substitutes a gum ingredient in the food product.

TABLE 1
The ingredients and the functionalities of the
plant-only composition/gum replacement system:

| Plant-derived ingredients of the plant- | |
|---|---|
| only composition/gum replacement | Functions of the |
| system | ingredients |
| Polysaccharides sources (e.g., Almond | The polysaccharides |
| polysaccharides, Oat flour, Quinoa flour, | sources are rich in non- |
| cassava flour, sunflower seeds flour, palm | starch polysaccharides |
| kernel meal, coconut flour, soya bean | (NSP). The presence of |
| hulls, sugar beet pulp, Pecan Flour, | various carbohydrates in |
| Cashew Flour, Macadamia Flour) | these gums also help in |
| | stabilizing the emulsions as |
| | they form structured films. |
| | It acts as stabilizer and |
| | emulsifier. |
| Plant-only mucilage (E.g., Quince seed | It forms polysaccharide |
| mucilage, Sweet basil seed mucilage, chia | hydrogel and has improved |
| seed mucilage, yellow mustard mucilage, | swelling power. |
| moringa seeds mucilage, fenugreek seeds | |
| mucilage, Cordia dichotoma seeds | |
| mucilage, arugula seeds mucilage, radish | |
| seeds mucilage, cress seeds mucilage, okra | |
| mucilage) | |
| Plant-only protein source (e.g., Mesquite | Plant-only protein source |
| protein, Pea protein, lupine, mushrooms, | has emulsification and |
| quinoa, chickpeas protein, Soy protein, | thickening properties. |
| pigeon pea, mung bean protein, peanut, | |
| pinto beans, oats, cow pea protein) | |
| Plant-only fiber mucilage (e.g., Linseed | Plant-only fiber mucilage |
| mucilage, Plantago Psyllium mucilage, | has fiber, improved water |
| Plantago ovata seeds mucilage, chia seeds | holding capacity (WHC), |
| mucilage, mucilages of mangosteen, | and increases |
| assyrian plum, prickly pear, cassava, | polyunsaturated to |
| Indian jujube fruit, Coromandel ebony, | saturated fatty acid ratio |
| orange fiber, tilkor fruit) | PUFA:SFA in food |
| | products. It increases fat |
| | content for products like |
| | burgers, rheology and has |
| | textural properties, |
| | swelling. Linseed |
| | mucilage is a rich source |
| | of omega3 and omega-6 |
| | fatty acids and high fiber |
| | makes it a good |
| | emulsifying, binding and |
| | stabilizing agent. |

### Plant-Only Gum Replacement System Food Product

Gums used as additives in commercially available food products generally bind, emulsify, texturize, retain water and improve cooking yields. Other types of highly processed or synthetic additives such as phosphates, maltodextrin and others have similar functionalities in food products and, as a result, the gum replacement system embodiments disclosed may replace those types of additives as well.

In some embodiments, the plant-only composition comprises (i) about 20% to about 40% weight by weight of almond polysaccharides, (ii) about 10% to about 20% weight by weight of quince seed mucilage, (iii) about 5% to about 20% weight by weight of mesquite protein, and (iv) about 5% to about 20% weight by weight of linseed mucilage. The plant-only composition substitutes a gum ingredient in the food product.

Table 2 shows the percent by weight of each of the preferred, essential plant-derived ingredients in the plant-only composition/gum replacement system (category 1), whose functionalities include binding, improving structure, stabilizing, improving consistency, and reducing cooking loss of the food products in which these replacement ingredients are added.

TABLE 2
The plant-only composition/gum replacement system

| Plant-Only Composition/Gum | Preferred Weight by Weight |
|---|---|
| Replacement System (Category | Percent (% ) of the Plant-Only |
| 1) Preferred, Essential | Composition/Gum |
| Ingredients | Replacement System |
| Almond polysaccharides | 20-40 |
| Quince seed mucilage | 10-20 |
| Mesquite protein | 5-20 |
| Linseed mucilage | 5-20 |

From the Table 2, within this category 1, set of gum replacement ingredients, one ingredient (or an alternative plant-derived ingredient exhibiting the same or similar functionalities and properties) may be used as the plant-only composition/gum replacement system. In other embodiments, two or more may be combined in varying amounts for the plant-only composition/gum replacement system. In some embodiments, all four of the preferred essential ingredients listed in Table 1 may be used as the plant-only composition/gum replacement system. In alternative embodiments, any of the ingredients listed may be replaced with one or more substitute ingredients that impart the same or similar properties and functionalities as each of the ingredients listed.

Further, although Table 2 provides a preferred, essential list of categories of ingredients with certain properties in the plant-only composition/gum replacement system, substitutions for these ingredients in the plant-only composition/gum replacement system may be made in alternative embodiments for compliance with dietary requirements; without limitation, such as food sensitivities and food allergies.

The plant-only composition/gum replacement system detailed in Table 2 as a component of a plant-only burger product or a Traditional Burger Product comprises generally between about 0.5 to about 3 percent dry weight of the total weight of the food product, but may vary between as much as 0.05 percent to about 10 percent or more of the total weight, depending on the moisture content of the plant-only composition/gum replacement system and that of the final food product (e.g., whether a plant-only burger product (Table 3) or a Traditional burger Product (Tables 5 and 6), whether a dry mix or other form).

TABLE 3
Various plant-only composition/gum replacement systems' ingredients
and combinations as components of plant-only burger products

| | Preferred |
|---|---|
| | Dry Weight |
| | by Weight |
| Preferred, Essential, Plant-Only Food Product | Percent (%) |
| Replacement Systems and/or Individual | of Plant-Only |
| Ingredients and Combinations | Burger Product |
| Protein sources (one or more of pea, mushroom, | 10-20 |
| quinoa, chickpeas) | |
| Methyl Cellulose (MC) replacement system | 5-10 |
| ingredients from all five categories (proteins; fibers | |
| from whole grains, fruits, seeds and vegetables; | |
| starches; and vegetable binders) within the ranges | |
| indicated for the plant-only composition/gum | |
| replacement system | |
| Modified Starches replacement system comprising four | 10-15 |
| starch source categories, including, among other | |
| ingredients, tapioca starch, faba bean starch, sorghum | |
| starch, quinoa starch and/or substitute(s) exhibiting | |
| similar or the same properties and functionalities) | |
| Oils providing high levels of omega-3 fatty acids, | 10-12 |
| MUFAs, & MCTs (e.g., sunflower oil, coconut oil, | |
| flaxseed oil, rice bran oil, or other oil providing such | |
| fats at desired levels ) | |
| Gum replacement system(s), any one or more of | 10-15 |
| categories 1-3, depending on the desired characteristics | |
| of the plant-only food product (i.e., one or more of four | |
| preferred, essential ingredients: almond polysaccharides, | |
| quince seed mucilage, mesquite protein and linseed | |
| mucilage, as well as and/or one or more substitute(s) for | |
| any of these ingredients exhibiting similar or the same | |
| properties and functionalities | |
| Shelf life extenders (one or more of garlic, black pepper, | 1-2 |
| oregano, bay laurel) | |
| Umami flavor (one or more of shitake and other | 0.5-2 |
| mushrooms, tomatoes, garlic, lotus stalk, onions, salt) | |
| Flavorant, flavor enhancer, nutraceutical (one or more of | 0.5-1 |
| cumin, coriander, paprika, black pepper) | |
| Flavor Enhancer (one or more of nutritional yeast, | 1-2 |
| cashews) | |
| Mineral Salts (Himalayan pink salt, sea salt, etc.) | 0.5-2 |
| Binding agents (one or more of chickpeas, oat fiber, | 5-10 |
| aquafaba, sugar beet pectin) | |
| Leavener replacement system ingredients from five | 0.5-1 |
| categories (plant-only fibers; fruit pectins; fruit acids; | |
| plant-only starches; and cereal sources) | |
| Leghemoglobin source(s) (one or more of beets, soy, red | 1-2 |
| radish) | |
| Lipid peroxidation inhibitors (one or more of black | 0.5-2 |
| pepper, bay leaf, cumin) | |

The plant-only composition/gum replacement system may comprise, as a percent by weight of the food product in which it is added, depending on the type of food product and whether water or other liquid is included as part of the food product, included but not limited to Traditional Burger Products and plant-only burger products, between about 0.05 to about 25 percent or more, between about 0.01 to about 0.10 percent, between about 0.10 to about 0.15 percent, between about 0.1 to about 5 percent, between about 0.15 to about 0.20 percent, between about 0.20 to about 0.25 percent between about 0.25 to about 0.30 percent, between about 0.30 to about 0.35 percent, between about 0.35 to about 0.40 percent, between about 0.40 to about 0.45 percent, between about 0.45 to about 0.50 percent, between about 0.50 to about 0.65 percent, between about 0.65 to about 0.70 percent, between about 0.70 to about 0.75 percent, between about 0.75 to about 0.80 percent, between about 0.80 to about 0.85 percent, between about 0.85 to about 0.90 percent, between about 0.90 to about 0.95 percent, between about 0.95 to about 1.00 percent, between about 1.00 to about 1.05 percent, between about 1.05 to about 1.10 percent, between about 1.10 to about 1.15 percent, between about 1.15 to about 1.25 percent, between about 1.25 to about 1.35 percent, between about 1.35 to about 1.50 percent, between about 1.50 to about 1.75 percent, between about 1.50 to about 2.0 percent, between about 1.75 to about 2.00 percent, between about 2.00 to about 2.25 percent, between about 2.25 to about 2.50 percent, between about 2.50 to about 2.75 percent, between about 2.75 to about 3.00 percent, between about 3.00 to about 3.25 percent, between about 3.25 to about 3.5 percent, between about 3.5 to about 4.5 percent, between about 4.5 to about 5.5 percent, between about 5.5 to about 6.5 percent, between about 6.5 to about 7.5 percent, between about 7.5 to about 8.5 percent, between about 8.5 to about 9.5 percent, between about 9.5 to about 10 percent, between about 10 to about 15 percent, between about 15 to about 20 percent, and between about 20 to about 25 percent.

Preferred, Essential Ingredients and their Interactions in the Plant-Only Composition/Gum Replacement System (Category 1)

The preferred, essential ingredients listed in Table 2 are identified by the Charaka machine learning system referenced above. One or more plant-only, minimally processed and non-synthetic alternative ingredients may also be used in the plant-only composition/gum replacement system (or may replace one or more of the listed ingredients). Such alternatives may be known to a person of ordinary skill to exhibit the same or similar functionalities and properties as one or more of the preferred, essential ingredients in the plant-only composition/gum replacement system.

Plant mucilage/plant-derived mucilage is a natural by-product of metabolism, formed in plant cell walls, and are thick, sticky substances, with similarities to gums. Mucilages comprise polymers of varying types, combined with uronic acid. Both gums and mucilages are hydrocolloids and comprise molecules that, when combined with water, form thick viscous or gel-like solutions.

Almonds are one example of a source of polysaccharides that can be used as part of a plant-only composition/gum replacement system in food products. Phytochemically, almond polysaccharides comprise carbohydrates, sterols, flavonoids, vitamins and phenolic compounds. In some embodiments, the almond polysaccharides are provided in the plant-only composition/gum replacement system as a finely ground powder. In other embodiments, they may be mixed with water, plant-derived liquid or other liquid to form a liquid, gel or other alternative form the system suitable for mixing and storing, freezing and/or drying. The almond polysaccharides promote the ayurvedic properties of Rasa: Madhura (sweet), Guna: Snigdha (slimy), Guru (heavy), Virya: Usna (hot), and Vipaka: Madhura (Sweet).

In the disclosed embodiments, the almond polysaccharides and/or a substitute with the same or similar properties and functionalities as these ingredients as a percent of the plant-only composition/gum replacement system weight, ranges from between about 5 to about 60 percent, between about 5 to about 10 percent, between about 10 to about 20 percent, between about 20 to about 30 percent, between about 30 to about 40 percent, between about 40 to about 50 percent, and between about 50 to about 60 percent.

The plant-only composition/gum replacement system may be used in any combination as components of one or more food products. In some embodiments, when certain ingredients of the plant-only composition/gum replacement systems are used together in a food product, they provide synergistic or enhanced functionalities and properties in combination that any one gum replacement system may not offer.

A unique blend of almond polysaccharides, quince seed mucilage and mesquite protein together, may act as a system of stabilizer and emulsifiers. Almond polysaccharides and mesquite protein reduce the interfacial tension between the oil and water phases and produce stable emulsions at low concentrations. The presence of various carbohydrates in these plant-only composition/gum replacement system also help in stabilizing the emulsions as they form structured films. Creaming, which may occur as a consequence of unstable emulsion formation, is prevented by the addition of quince seed mucilage. Mesquite seeds provide a higher protein quality than soybeans, a well-known legume used by the food industry.

Almond polysaccharides exhibit similar gelatinization properties to those of gum arabic, for example; their use results in delayed gelatinization of starch molecules. Both have high water binding capacities, which could diminish the gelatinization of starch particles since both would be competing for available water. While this could negatively affect binding in a burger product, the combination of almond polysaccharides with quince seed mucilage and other plant-derived ingredients in a burger product such as chickpeas and pectins, may compensate for the lesser ability of almond polysaccharides alone to bind water. The combination in a plant-only burger product, for example can result in greater moisture retention in food products, resulting in reduced cooking loss. Food products containing conventionally used gums may not retain as much moisture through the cooking process.

Linseed is rich in fiber, omega-3 and -6 fatty acids, and phenolic compounds. It comprises roughly 6% mucilage, predominantly composed of arabinoxylans, which are non-starch polysaccharides. Linseed mucilage powder increases the protein and fat content, and decreases the moisture in raw meat burgers, and further reduces fat absorption in frying. It increases the polyunsaturated to saturated fatty acid ratio (PUFA:SFA) of a food product, improving the cooking yield (reduces loss); it also improves water holding capacity.

In some embodiments, the linseed mucilage is provided in the plant-only composition/gum replacement system as a finely ground powder. In other embodiments, they may be mixed with water, plant-derived liquid or other liquid to form a liquid, gel or other alternative form the system suitable for mixing and storing, freezing and/or drying. The linseed mucilage promotes the ayurvedic properties of Rasa-Madhura, Guna-Snigdha (Oily/Smooth), Picchil (Slimy), Virya-Ushna (hot), and Vipaka-Katu (pungent).

In the disclosed embodiments, the linseed mucilage and/or a substitute with the same or similar properties and functionalities as these ingredients as a percent of the plant-only composition/gum replacement system weight, ranges from between about 1 to about 30 percent, between about 1 to about 5 percent, between about 5 to about 10 percent, between 5 to about 20 percent, between about 10 to about 15 percent, between about 15 to about 20 percent, between about 20 to about 25 percent, and between about 25 to about 30 percent.

The linseed mucilage exhibits a high water-binding capacity, which affects the amount of swelling in food products; this helps to impart desirable rheology and textural properties of the food product, particularly cooked burger products. Quince seed mucilage and almond polysaccharides exhibit high water binding capacities and contribute to resistance to water lost in cooking, as does the combination of linseed and quince seed mucilages. Myofibrillar proteins (principally actin and myosin) play a crucial role in the texture and water retention in cooked food products. The linseed mucilage facilitates the myofibrillar protein unfolding before aggregation and creates a gel with a fine pore size; this helps retain water in myofibrillar structures by capillary forces and increases the water-binding capacity. By adding the linseed mucilage, the hydrophilic part of the fibers make gel in contact with the water and result in greater water-binding capacity and lower fat absorption. During frying, because of water loss (evaporation), dry matter and total fat content increase, Therefore, by increasing the water holding capacity, the fat absorption amount may decrease during frying/cooking. The addition of linseed mucilage to the plant-only composition/gum replacement system (at least 4-5 percent of the total dry weight of the plant-only composition/gum replacement system) significantly improves the organoleptic performance, attributable to the volatile compounds present in linseed, i.e., acetaldehyde, ethanol, hexanal, and 2-methylbutanal. The linseed mucilage is a rich source of omega-3 and omega-6 fatty acids and high fiber makes it a good emulsifying, binding and stabilizing agent.

Quince seed mucilage is comprised of glucuronic acid and xylose (glucuronoxylan, an inexpensive polysaccharide hydrogel); it is insoluble in water and swells significantly. Quince seeds are at the same time, sweet, bitter, and astringent. The main chemical constituents of quince seeds include sterols, triterpenes, tannins, phenolic acids, organic acids, amino acids, ionone glycosides, and essential oils.

In some embodiments, the quince seed mucilage is provided in the plant-only composition/gum replacement system as a finely ground powder. In other embodiments, they may be mixed with water, plant-derived liquid or other liquid to form a liquid, gel or other alternative form the system suitable for mixing and storing, freezing and/or drying. The quince seed mucilage promotes the ayurvedic properties of Rasa: Madhura (Sweet), Titka (Bitter), Kashya (Astringent), Guna: Laghu (Light), Ruksha (Dry) Virya: Ushna (Hot), and Vipaka: Katu (Pungent).

In the disclosed embodiments, the quince seed mucilage and/or a substitute with the same or similar properties and functionalities as these ingredients as a percent of the plant-only composition/gum replacement system weight, ranges from between 1 to about 30 percent, between about 1 to about 5 percent, between about 5 to about 10 percent, between 5 to about 20 percent, between about 10 to about 15 percent, between about 15 to about 20 percent, between about 20 to about 25 percent, and between about 25 to about 30 percent.

The final texture of the food product in which these ingredients are used may be thicker and stiffer due to the binding of water-soluble starches by the pectins (mucilages) and proteins. The presence of globulins and albumins (proteins) exhibit excellent water and oil binding capacity. The presence of hydrocolloids and starches may reduce adhesiveness as the ingredients form a stable network structure that entraps starch granules, slowing down the amylose release during cooking. Hydrocolloids and starches also help to form a strong protein network, increasing the cohesiveness of the food product. The hydrophilic component in the hydrocolloids interacts ionically with the proteins in the food product to improve the food product's structure in, e.g., a Traditional Burger Product or plant-only burger product.

Mesquite Proteins are “surface active,” interacting through electrostatic or hydrophobic/hydrophobic interactions, and thus can play a major role in the formation and stabilization of emulsions in the presence of polysaccharides. Polysaccharides are hydrophilic and may remain in an aqueous phase, and so participate thickening, stabilizing, binding and gelling. Emulsion stability is achieved through interaction between polysaccharides and proteins present in the combination. Cooking loss, including shrinkage is reduced in fried food products, such as various forms of burger products (i.e., burgers, crumbles, etc.). Higher protein levels in a food product also may reduce adhesiveness and cohesiveness, and affect moisture content, such as juiciness of a Traditional Burger Product or plant-only burger product. Compared to other legumes such as peas, the protein content of mesquite is similar, but the amino acid profile differs. The combination of quince seed mucilage and mesquite proteins act as an emulsifier and excellent binding agent, providing structure and firmness to the food product.

In some embodiments, the mesquite protein is provided in the plant-only composition/gum replacement system as a finely ground powder. In other embodiments, they may be mixed with water, plant-derived liquid or other liquid to form a liquid, gel or other alternative form the system suitable for mixing and storing, freezing and/or drying. The mesquite protein promotes the ayurvedic properties of Rasa-Tikta (bitter), Katu (pungent), Guna-Laghu (light) Ruksha (dry), Virya-Sheeta (cold), Vipaka-Katu.

In the disclosed embodiments, the mesquite protein and/or a substitute with the same or similar properties and functionalities as these ingredients as a percent of the plant-only composition/gum replacement system weight, ranges from between about 1 to about 30 percent, between about 1 to about 5 percent, between about 5 to about 10 percent, between 5 to about 20 percent, between about 10 to about 15 percent, between about 15 to about 20 percent, between about 20 to about 25 percent, and between about 25 to about 30 percent.

The stability of the plant-only composition/gum replacement system during storage is maintained at temperatures above room temperature. Stability may increase further when both almond polysaccharides and quince seed mucilage are included because they both have antioxidant and antibacterial properties, and thus function as preservatives. As a result, hydrocolloids in the plant-only composition/gum replacement system ingredients form a strong network and interact with other components in food products. In either Traditional Burger Products or plant-only burger products, the plant-only composition/gum replacement system ingredients, or their alternatives having the same or similar functionalities and properties, promote structural stability and integrity of the food product.

The single ingredients of the plant-only composition/gum replacement system and their various combinations along with their Ayurvedic properties (as shown in Table 4) results in a plant-only composition/gum replacement system that may be use in whole or part in any variety of food products, the primary example of the disclosed embodiments for Traditional Burger Products and other burger products. Alone or in combination as a plant-only composition/gum replacement system, the previously described ingredient categories are effective and natural components in the plant-only composition/gum replacement system for burger products, baked products or other food product categories in an amount of about 0.5 percent to up to 25 percent or more by weight of the food product, depending on the type of food product and the replacement ingredients needed or desired, as indicated above in the paragraph following Table 3. Table 3 above shows preferred weight range percentages within a plant-only burger product for the plant-only gum replacement system (category 1), as well as for other replacement systems and categories of other replacement ingredient combinations. Note that the plant-only gum replacement system may be incorporated in much lower amounts in other food products. Traditional Burger Products including so-called plant-based burger products may have a much lower quantity of plant-only gum replacement system ingredients, e.g., range 0.1 to 5 percent of the weight of the food product.

### Preparation of the Plant-Only Composition/Gum Replacement System and Individual Ingredients

In one embodiment, the plant-only composition/gum replacement system, individual ingredients or combinations of ingredients can be prepared by combining and mixing the dried, powdered ingredients selected from Table 2 in the relative amounts identified as preferred, essential ingredients of the system to be used in a desired food product. In some embodiments, the plant-only composition/gum replacement system may be in the form of a liquid or gel due to the addition of water or other plant-derived liquid to one or more of the ingredients or categories of ingredients before mixing, such as, for example, aquafaba in liquid form. In some embodiments, the plant-only composition/gum replacement system is mixed with additional water or plant-derived liquid, then dried and powdered and stored. In some embodiments, the plant-only composition/gum replacement system is prepared in liquid form and freeze dried. In certain embodiments, the plant-only composition/gum replacement system may be prepared and stored as a liquid or moist form (as in a gel or dough). In certain other embodiments, the plant-only composition/gum replacement system may be prepared as a liquid, gel or in dried form and then frozen for storage. In other embodiments, each of the categories of ingredients, individual ingredients, or combinations of ingredients within each of the categories of the plant-only composition/gum replacement system, whether in liquid, gel, dried or other form, are mixed individually directly into and become a part of another food product rather than being combined as the complete replacement system prior to incorporation into another food product.

In some embodiments, the plant-only composition/gum replacement system stands alone as a plant-only food product. In other embodiments, the plant-only composition/gum replacement system is a component of another food product, such as a plant-only burger product, or other imitation meat product. In certain embodiments, the plant-only composition/gum replacement system is a component of a baked good food product, or a frozen burger or burger mix, which may then be incorporated into other food products. In still other embodiments, the food product is one of several components used to create final food product. In other embodiments, the food product is a Traditional Burger Product. In some embodiments, the ingredients of Table 2 may be selected and combined in other relative amounts (a variety of ranges) identified for each of the four gum replacement system ingredients discussed infra to achieve the required functional characteristics most closely resembling those of conventionally used gums in a variety of food products, including, e.g., Traditional Burger Products.

The combination of categories and ingredients comprising a plant-only composition/gum replacement system for traditional ingredients and additives in commercially available animal-based and plant-based products, as well as their physicochemical and Ayurvedic properties are shown in Table 4.

TABLE 4
Plant-only composition/gum replacement system's
(Category 1) ingredients and their properties

| Ingredients of the Plant- | | |
|---|---|---|
| only composition/gum | | |
| replacement system and | | |
| their Sources Responsible | | Ayurvedic |
| for the Desired Functionality | Physicochemical properties | properties |
| Almond polysaccharides | pH: 3.9 to 4.4 | Rasa: |
| Almonds are mainly | Moisture: 12.5% to 15.0% | Madhura |
| composed of 92.36% of | Bulk Density: 0.6 gram per | (sweet) |
| polysaccharides (dry | milliliter (g/ml) | Guna: |
| weight basis) with the | Porosity (%): 42.06 | Snigdha |
| major sugar composition | Viscosity: Increases viscosity | (slimy), |
| being arabinose (46.83%), | upon addition in food product | Guru (heavy) |
| galactose (35.49%) and | Stability: It is similar to that of | Virya: |
| uronic acid (5.97%). | gum arabic. The stability of 10% | Usna (hot) |
| Almonds also comprise ~2.45% | oil emulsions with almond | Vipaka: |
| protein. | polysaccharides is comparable to | Madhura |
| | those using gum arabic. | (Sweet) |
| Quince seed mucilage | Moisture: 5.8% | Rasa: |
| The main fraction of | Viscosity at shear rate: 1473.96 | Madhura |
| Quince seed mucilage is | millipascal seconds (mPa · s) at | (Sweet) |
| high-molecular-weight | shear rate of 46.16 inverse second | Titka |
| polysaccharides and the | (1/s) | (Bitter) |
| most abundant among them | Emulsion stability: 94.89% | Kashya |
| include | Foam stability: 21.36% | (Astringent) |
| d-Xylan, which comprises | Zeta potential measurement: | Guna: |
| large amounts of | The absolute values of zeta | Laghu |
| glucuronic acid residues. | potential measurements of | (Light) |
| The quince seed mucilage | Quince seed mucilage are | Ruksha |
| also comprises protein | greater than 30 millivolt (mV), | (Dry) |
| (2.2%), which may affect | indicating an emulsion system | Virya: |
| the interfacial tension at | with good physical stability | Ushna |
| the oil-water interface; | | (Hot) |
| interfacial tension directly | | Vipaka: |
| affects the emulsification | | Katu |
| stability. | | (Pungent) |
| Mesquite protein | pH: 4.38 | Rasa - |
| | Moisture: 9.7% to 10.2% | Tikta |
| Mesquite seeds comprise | Viscosity: The gum exhibits | (bitter), |
| ~68% protein. Their | shear thickening behavior at | Katu |
| complex carbohydrate | concentration above 20%. | (pungent) |
| composition includes D- | Aqueous solution of mesquite | Guna - |
| galactose, L-arabinose, D- | protein (20% concentration, | Laghu |
| glucuronate, D-mannose | w/w) in 0.1 molar (M) sodium | (light) |
| and D-xylose. Mesquite | chloride at 20° C. temperature | Ruksha |
| seed comprises an | exhibits viscosity values of 25-30 | (dry) |
| endosperm rich in | mPa · s. Molecular | Virya - |
| galactomannans, a | weight: 484,000 g/mol (g/mol) | Sheeta |
| polysaccharide widely used | Stability: mesquite protein from | (cold) |
| as a stabilizing and | Prosopis alba is a better emulsion | Vipaka - |
| emulsifying agent in food | stabilizer versus arabic gum due | Katu |
| products. | to its higher zeta potential, lower | |
| | polydispersity index, lower | |
| | creaming index, higher interfacial | |
| | film elasticity and lower average | |
| | droplet size distribution. | |
| Linseed mucilage | Linseed powder increases the | Rasa- |
| Linseeds is rich in | protein and fat content, and | Madhura |
| fiber, omega-3 fatty | decreases the moisture in raw | Guna - |
| acids, and | meat burgers, and further | Snigdha |
| phenolic compounds | reduces fat absorption in frying. | (Oily/Smo |
| | It increases the polyunsaturated | oth), |
| | to saturated fatty acid ratio | Picchil |
| | (PUFA:SFA), improving the | (Slimy) |
| | cooking yield (reduces loss); it | Virya- |
| | also improves water holding | Ushna |
| | capacity. | (hot) |
| | | Vipaka - |
| | | Katu |
| | | (pungent) |

Table 5 below provides an overview of the typical formulation of a commercially available, meat-based burger, including preservatives and other chemical additives.

TABLE 5
Typical formulation for commercially
available meat-based burgers.

| | Weight by | |
|---|---|---|
| | weight | |
| Meat-based | percent (%) | |
| Ingredient/category | of burger | Function |
| Beef/Pork | up to 60-70 | Meat-based protein and fat |
| | | source |
| Water | up to 10 | Moisture |
| Beef Fat | up to 15-20 | Animal fat source |
| Soy Protein | up to 10-15 | Protein source |
| Salt | up to 10-15 | Flavor |
| Caramel color | 5-15 | Colorant |
| Sodium | 2-4 | Stabilizer, meat curer |
| polyphosphates | | |
| Maltodextrin | 0.25-0.75 | Fat replacer, shelf life extender |
| Cochineal carmine | 5-15 | Colorant |
| Monosodium glutamate | 0.1-0.8 | Flavoring agent |
| Onion | 5-10 | Preservative, flavor enhancer |
| Garlic | 5-10 | Preservative, flavor enhancer |
| Cumin | 1-5 | Preservative, flavor enhancer |
| Sodium erythorbate | 0.5-0.7 | Cure accelerator |
| Natural beef/pork | 1-2 | Flavor |
| flavors | | |
| Sodium citrate | 2-3 | Acidity regulator |
| Disodium inosinate | 0.1-0.3 | Flavor enhancer |
| Sodium guanylate | 0.1-0.3 | Flavor enhancer |
| Black pepper | 1-5 | Flavor enhancer |
| Capsicum | 1-5 | Flavor enhancer |
| Soybean | 10-40 | Textured vegetable protein |
| Nisin | 0.01-0.05 | Preservative |
| Nitrites and Nitrates | 1-5 | Taste, colorant, antimicrobial |
| Phosphate Salts | 0.1-0.5 | Moisture retention, stabilizer, |
| | | shrinkage reducer, flavor |
| | | enhancer, colorant |
| Tertiary | 0.02-0.03 | Antioxidant |
| butylhydroquinone | | |
| (TBHQ) | | |

In some embodiments, the plant-only composition/gum replacement system when added to meat-based products within the Traditional Burger Products such as in the example above, replaces some or all of the phosphate salts, maltodextrin and a small percent of soybean, in an amount between about 0.5 and about 5 percent or more of the weight of the food product, as in the example above.

Table 6 below, similarly provides an overview of the typical formulation of a commercially available, plant-based burger or burger mix, with numerous chemical additives. Although a somewhat improved profile compared to the profile of the formulation of the meat-based burger shown in Table 5, it can be improved for certain consumer diets with the use of plant-only replacements such as the plant-only composition/gum replacement system. The plant-only composition/gum replacement system may also be used to improve the quality of meat-based food products intended for pets and other animals.

TABLE 6
Typical formulation for commercially
available, plant-based burgers.

| | Weight by | |
|---|---|---|
| | weight | |
| | Percent | |
| Plant-based Burger | (%) of | |
| Ingredient/Category | Product | Function |
| Pea protein isolate | 70-80 | Protein source |
| Water | Variable | Moisture |
| Expeller-pressed canola | 2-5 | Fat source |
| oil | | |
| Refined coconut oil | 20-25 | Fat source |
| Cellulose from bamboo | 52 | Texturizer |
| Methylcellulose | 0.1-2 | Thickener, emulsifier, and binder |
| Potato starch | 2-4 | Thickener |
| Flavoring agents | 10-15 | Flavor |
| Maltodextrin | 0.2-0.9 | Fat replacer, shelf life extender |
| Yeast extract | 1-2 | Flavor enhancer |
| Salt | 2-5 | Flavor |
| Sunflower oil | 8-10 | Fat source |
| Vegetable glycerin | 5-15 | Sweetener |
| Dried yeast | 1-3 | Flavoring agent |
| Gum arabic, konjac | 0.1-1 | Emulsifier, binder, stabilizer, |
| gum, xanthan gum, | | thickener, foaming agent, |
| Locust bean gum, | | texturizer, moisture retention. |
| carrageenan | | |
| Citrus extract (to | 1-3 | Antimicrobial, preservative |
| protect quality) | | |
| Ascorbic acid (to | 0.1-1 | Color retention |
| maintain color) | | |
| Beet juice extract (for | 5-10 | Colorant |
| color) | | |
| Acetic acid | 0.5-2 | Shelf life extender |
| Succinic acid | 1-2 | Acidulant/flavoring agent |
| Modified food starch | 5-15 | Texturizer |
| Annatto (for color) | 2-5 | Colorant |

In some embodiments, the plant-only composition/gum replacement system when added to plant-based burger products such as in the example above, replaces some or all of the gums used in commercially available plant-based burger products: gum arabic, konjac gum, xanthan gum, Locust bean gum, carrageenan at the same levels, e.g., as shown above, in a range of approximately 0.1 to 1 percent, and up to 5 percent or more.

Table 7 below provides a comparison of the commercial plant-based versus currently disclosed, plant-only composition/formulations burger products with a variety of replacement systems.

TABLE 7
Comparison of formulations of plant-based burgers and burger mixes versus
commercially available plant-only burgers and burger mixes, indicating
relevant replacements for traditional additives in plant-based burger.

| Example Formulation | |
|---|---|
| of Commercially | |
| Available Plant-based | |
| Burger Products with | Plant-only Composition/Formulation for Burger |
| Traditional Additives, | Products Replacing Commercially Available |
| Including Gums | Gums |
| Pea protein isolate | One or more protein source(s) (peas, lupine, |
| | mushrooms, quinoa, chickpea, etc.) |
| Water | Water (from plant or external source) |
| Expeller-pressed canola | One or more oils (sunflower, coconut, flaxseed and |
| oil | rice bran) comprising high levels of MUFAs, omega- |
| Refined coconut oil | 3 fatty acids, & MCTs |
| Sunflower oil | |
| Cellulose from bamboo | Plant-derived methyl cellulose (MC) replacement |
| Methylcellulose | system (blend of five categories of ingredients: |
| | protein, fibers from whole grains; fibers from fruits, |
| | seeds and vegetables, vegetable binding agents and |
| | starches (0.5-30% weight of the plant-derived burger |
| | product, depending on whether water or other liquid |
| | is included in the burger product or other mix). |
| Annatto (for color) | Plant-derived color and flavorants, nutraceuticals |
| Natural flavor | (one or more of cumin, coriander, paprika, black |
| | pepper, etc.) |
| | Plant-derived umami flavor replacement system (one |
| | or more of shiitake and other mushrooms, tomatoes, |
| | garlic, lotus stalk, onions, mineral salts, etc.) |
| Maltodextrin | Plant-derived shelf-life extender |
| | (one or more of garlic, black pepper, oregano, bay |
| | leaf etc.) |
| Yeast extract | Flavor enhancer (one or more of nutritional yeast, |
| Vegetable glycerin | cashews etc.) |
| Dried Yeast | Plant-derived leavener replacement system |
| | (combination of ingredients from five categories, |
| | including one or more of psyllium husk, apple |
| | pomace, rice starch, faba beans, plum powder, etc.) |
| Salt | Mineral Salts (Himalayan pink salt, sea salt) |
| Gum arabic, konjac | Plant-only gum replacement system (one or more |
| gum, xanthan gum, | of quince seed mucilage, linseed mucilage, mesquite |
| locust bean gum, | protein, and almond mucilage, or one or more |
| carrageenan | equivalents or alternatives as noted elsewhere) |
| Citrus extract (to protect | Plant-derived leghemoglobin (one or more of beets, |
| quality) | red radish, etc.) |
| Ascorbic acid (to | |
| maintain color) | |
| Beet juice extract (for | |
| color) | |
| Acetic acid | Plant-derived shelf life extender (one or more of |
| | garlic, black pepper, onion etc.) |
| Succinic acid | Plant-derived flavor enhancer (one or more of |
| | paprika, black pepper, beet juice, etc.) |
| Modified food starch | Plant-derived modified starches replacement (one |
| Potato starch | or more of tapioca, faba bean, sorghum, quinoa, etc.) |

TABLE 8
Parameters and Ranges for Plant-only composition/gum replacement system

| Ingredients | Parameters & Ranges | | | |
|---|---|---|---|---|
| Almond | Amount of | Swelling | Emulsion | |
| polysaccha | polysaccharides/ | index: | stability: | |
| rides | Non starch | 22.58% | ~45.83 to | |
| | polysaccharide: | to 87.44 ± | 92.6% or more | |
| | 20%-92.36% | 0.310% | The EC values | |
| | or more | or more | increase | |
| | | (Here, it | proportionally | |
| | | indicates | to almond gum | |
| | | that almond | concentrations | |
| | | gum has a | (w/v). | |
| | | good water | | |
| | | uptake | | |
| | | capacity) | | |
| Quince | Viscosity at | Water | Emulsion | |
| seed | shear rate of | holding | stability: | |
| mucilage | 46.16 1/s | capacity: | 35%-94.89% | |
| | ~1000 mPa · s | ~10.27 grams | | |
| | or more | water per | | |
| | | gram (g/g) | | |
| | | to 92.50 ± | | |
| | | 1.63 g/g | | |
| Mesquite | Molecular | Emulsion | Water | Non- |
| protein | weight 10-50 | Stability : | Holding | Newtonian: |
| | kilodaltons | 35%-90% | Capacity | shear |
| | (kDa) | or more | ~100%-600% | thickening |
| | | | | behavior |
| Linseed | PUFA/SFA | Water | Emulsion | |
| mucilage | ratio ~7.40 | holding | stability : | |
| | | capacity | 42.22 to | |
| | | ~2.57 g/g- | 70% or | |
| | | 28.66 g/g | more. | |
| | | or more | | |

Table 9 below provides a detailed description of the functionality of the various plant-only composition/gum replacement systems and other categories of ingredients specific to plant-only burger products, as determined by the Charaka machine learning system described above.

### Functionality of Plant-Only Composition/Gum Replacement Systems for Burger Products

The unique combination of essential ingredients in each plant-only composition/gum replacement systems, including individual ingredients or combinations of ingredients within each category of the system provides certain functionalities necessary for quality, plant-only burger products, as shown in the following table.

TABLE 9
Functionalities Provided by Plant-Only Composition/Gum
Replacement Systems in Burger Products

| | Plant-only | Plant-derived Ingredients, Ingredient |
|---|---|---|
| | Burger Product | Combinations of Plant-only Composition |
| | Essential | or Gum Replacement Systems Enabling |
| | Ingredients and | Functionality within the |
| Function | Combinations | Burger Product Composition |
| Emulsifier | One or more oils | Sunflower oil is primarily (85%) |
| | providing high | unsaturated fatty acids comprising 14- |
| | levels of MUFAs, | 43% oleic acid and 44-75% linoleic |
| | omega 3 fatty | acid, the latter, which results in the oil's |
| | acids, & MCTs | lower freezing point, and contributes to |
| | (sunflower oil, | the lower freezing points of products in |
| | coconut oil, | which sunflower oil is added. |
| | flaxseed oil, rice | Coconut oil, in contrast, is ~87% |
| | bran oil, or other | saturated fatty acids, lauric acid |
| | oil substitute | accounting for ~49% of the saturated |
| | exhibiting the | fats. Other saturated fatty acids include |
| | same or similar | myristic, palmitic, stearic, oleic, capric |
| | properties and | and caprylic acids. |
| | functionality) | Flaxseed comprises ~35-45% oil and |
| | | 20-30% protein. The oily portion |
| | | consists of 9-10% saturated fatty |
| | | acids (palmitic and stearic), ~20% |
| | | monounsaturated fatty acids (mainly |
| | | oleic acid), and more than 70% alpha- |
| | | linolenic fatty acids acid. |
| | | Rice bran oil comprises ~74% |
| | | unsaturated fatty acids (~30% linoleic |
| | | acid, ~44% oleic acid), and the |
| | | remaining ~23% are saturated fatty |
| | | acids. |
| Thickening | Thickeners and | Chickpea fractions (starch, proteins) |
| agents/ | binding agents | function as binders and are also a |
| binding agent | (one or more of | protein source (72-85% are globulins |
| | chickpeas, oat | and albumin). Protein matrices formed |
| | fiber, passion | have the ability to hold water and fat. |
| | fruit, aquafaba, | Their binding properties are also |
| | sugar beet | attributable to water soluble and |
| | pectin, and/or | insoluble carbohydrates: cellulose, |
| | substitute(s) with | starch and hemicellulose. Soluble |
| | the same or | carbohydrates have higher water |
| | similar | binding capacities, and water soluble- |
| | functionality and | and insoluble polysaccharides also |
| | properties) | absorb oil. |
| | | Oat fiber retains water, decreases |
| | | cooking losses and has neutral flavor. |
| | | Oats have a fiber type of β-glucan, a |
| | | soluble fiber accounting to 4%. It |
| | | depicts functional properties as a |
| | | potential binding agent. Oat fiber |
| | | provides the flavor, texture and |
| | | mouthfeel of fat. |
| | | Passion fruit has a high proportion |
| | | (52%) of insoluble dietary fiber |
| | | (cellulose, hemicellulose, and pectin), |
| | | which contributes to strong fat and |
| | | water retaining abilities. The fruit |
| | | comprises moderate length cellulose |
| | | fibers, contributing to a moderate |
| | | ability to retain fat. Cellulose interlinks |
| | | with hemicellulose and forming a fiber |
| | | net, increasing the surface area of |
| | | individual fibers, and contributing their |
| | | water and oil retention properties. |
| Texturizer/ | Modified starch | Tapioca starch is an excellent |
| gelling agent | replacement | thickener, binder, texturizer and |
| | system (one or | stabilizer. |
| | more of tapioca | Sometimes called tapioca flour, this |
| | starch, faba | starch originates from the cassava plant. |
| | bean, sorghum | Gelatinized (tapioca) starch can hold a |
| | starch, quinoa | significant amount of water, which |
| | starch, rice | helps improve the texture of many |
| | starch or | food products, including, among others, |
| | substitute | burgers and burger mixes. |
| | exhibiting the | The faba bean protein is glossy and |
| | same or similar | sticky, and is an important emulsifier, |
| | functionality and | foam stabilizer, and contributes to gel |
| | properties) | formation. Its protein constituents |
| | | include globulin and albumin |
| | | accounting for ~25-30% of its content; |
| | | these proteins do not contribute as |
| | | much as the other constituents to the |
| | | gelling capacity. |
| | | The quinoa starch is relatively low in |
| | | amylose content (e.g., 11%), and has |
| | | very small granules (1 to 3 μm) The |
| | | starch has unique properties such as |
| | | low pasting temperature, high freeze- |
| | | thaw stability, and water holding |
| | | capacity. The protein from quinoa flour |
| | | helps provide structure and shape to |
| | | the system. The protein and starch both |
| | | contribute to the gelling property. |
| | | Sorghum starch consists mainly |
| | | amylopectin and amylose. While |
| | | heating, the gelatinization of starch |
| | | occurs due to hydrogen bonds being |
| | | broken within the starch granule due to |
| | | water influx, which results in granular |
| | | swelling, increasing viscosity, which |
| | | thickens and texturizes the food |
| | | product. |
| Shelf life | Plant-derived | Garlic (Allium sativum) is one of the |
| extender; | shelf life | commonly used plants to enhance |
| preservative, | extenders (any | flavor. It produces a wide spectrum of |
| flavoring | one or more of | actions which have led to its use as an |
| agent, | herbs and spices, | antibacterial, antifungal, and |
| stabilizer | including garlic | antioxidant agent. The presence of |
| | extract, | allicin, a sulfur-containing compound, |
| | Himalayan pink | is responsible for the antimicrobial |
| | salt; black | effects. |
| | pepper, oregano, | Himalayan pink salt comprises |
| | bay laurel and/or | substantially higher levels of calcium, |
| | any substitute(s) | iron, magnesium, manganese, |
| | that exhibit the | potassium, aluminum, barium, silicon, |
| | same or similar | and sulfur, but lower levels of sodium |
| | functionality and | compared to the white table salt |
| | properties) | Black pepper, Piper nigrum, has |
| | | piperine in higher amounts that enables |
| | | the antimicrobial activity. Terpenes and |
| | | flavonoids also contribute to its |
| | | activity. The essential oil content in |
| | | black pepper mainly consists of |
| | | caryophyllene (30.3%) and limonene |
| | | (12.12%), both of which also |
| | | contribute to its antimicrobial activity. |
| | | Oregano, Origanum vulgare, along |
| | | with its flavor imparting action, |
| | | contributes to antimicrobial and |
| | | antioxidant properties. The major |
| | | components of oregano essential oil |
| | | are carvacrol, β-fenchyl alcohol, |
| | | thymol, and γ-terpinen. These |
| | | compounds have a free radical |
| | | scavenging effect contributing to |
| | | enhanced shelf life. |
| | | Bay leaf comprises 1.3% essential oils |
| | | that contribute to both flavor and shelf |
| | | life enhancement. These oils include |
| | | primarily eucalyptol (45%) but also |
| | | other terpenes (~12%), terpinyl acetate |
| | | (8-12%), sesquiterpenes (3-4%), |
| | | methyl eugenol (3%), and smaller |
| | | amounts of other α- and β-pinenes, |
| | | phellandrene, linalool, geraniol, |
| | | terpineol and lauric acid. These |
| | | compounds exhibit radical scavenging |
| | | and antimicrobial activity. |
| Flavoring | Umami flavor | Meat and other animal-based products |
| agent/ | source(s) (one or | can be replaced in some food products |
| umami | more of shitake | with one or more types of mushrooms |
| flavor | and other | without compromising flavor, and can |
| | mushroom types, | improve nutritional quality by reducing |
| | onions, | sodium, calories, saturated fat, and |
| | tomatoes, garlic, | cholesterol content. Mushrooms impart |
| | lotus stalk, salt, | an “umami” flavor because of their |
| | and/or any | flavor-enhancing compounds, most |
| | substitute(s) for | noticeably the eight carbon (C8) |
| | these exhibiting | volatile compounds. Among all C8 |
| | the same or | compounds, the most important for |
| | similar | mushroom flavor are oct-1-en-3-ol, |
| | functionality and | octan-3-ol, octan-3-on and oct-1-en-3-on. |
| | properties) | Onion (Allium cepa L.) comprises high |
| | | levels of flavonoids that enhance the |
| | | flavor of food products. Onions |
| | | contribute to the umami flavor of food |
| | | with their high glutamic acid content |
| | | (~25 to 50 mg/100 g). |
| | | Tomatoes impart a unique flavor, the |
| | | result of a complex mix and interaction |
| | | among sugars, acids, and volatile |
| | | compounds. They also are high in g |
| | | lutamate (~250 mg/100 g). |
| Flavorants/ | One or more | Paprika oleoresin comprises a number |
| flavor | flavorants/flavor | of carotinoids and pigments, including, |
| enhancers, | enhancers, | among others, capsanthin and |
| nutraceutical | nutraceuticals | capsorubin, which are strong |
| | (one or more of | antioxidants. Paprika is low in |
| | herbs and spices | capsaicin, the pungent (hot) compound |
| | such as cumin, | found in red peppers. |
| | paprika, | Methoxypyrazines” in paprika are |
| | coriander, black | responsible for its vegetative flavor. |
| | pepper, onion, or | The sweetness of paprika comes from |
| | a substitute(s) | a sugar content (up to 6%). Paprika has |
| | that exhibit the | important bioactive compounds such |
| | same or similar | as carotenoids, quercetin glycosides, |
| | functionality and | and luteolin, all of which exhibit high |
| | properties) | antioxidant activity. |
| | | Onions (Allium cepa L.) comprise |
| | | phytonutrients such as: flavonoids, |
| | | fructooligosaccharides (FOS), |
| | | thiosulfide and other sulfur compounds, |
| | | which are recognized as important |
| | | elements of highly nutritional |
| | | molecules. Quercetin is the main |
| | | flavonoid present in onions, exhibiting |
| | | antioxidant and antimicrobial |
| | | properties. |
| | | Black pepper (P. nigrum) comprises |
| | | numerous flavor compounds and has |
| | | antimicrobial and antioxidant |
| | | properties. The primary volatile flavor |
| | | compounds include terpenes: |
| | | monoterpene hydrocarbons (59.2- |
| | | 80.1%) and sesquiterpene |
| | | hydrocarbons (17.0-37.7%) while |
| | | oxygenated terpenoids accounted for |
| | | about 1.3-2.7%. Key odorants of black |
| | | pepper are α- and β-pinene, myrcene, |
| | | α- phellandrene, limonene, linalool, |
| | | methyl propanal, 2- and 3- |
| | | methylbutanal, butyric acid, |
| | | germacrene, and 3-methylbutyric acid. |
| | | The spiciness of black pepper comes |
| | | from Piperine. Germacrene is potent, |
| | | spicy, warm and has a sweet aroma. In |
| | | contrast, limonene is sweet, orange, |
| | | citrus and terpy. The essential oil |
| | | content in black pepper mainly |
| | | comprises of caryophyllene (30.3%) |
| | | and limonene (12.12%) also contribute |
| | | to antioxidant activity. |
| | | Cumin is a seed spice belonging to the |
| | | family Umbelliferae. Cumin and |
| | | products flavored by cumin are used in |
| | | food products and perfumery. Cumin |
| | | comprises ~2.3 to 4.8% of volatile |
| | | oils. The characteristic odor of cumin |
| | | is mainly due to the aldehydes present |
| | | in the seeds, namely, cuminaldehyde |
| | | (45-50%), p-menth-3-en-7-al and p- |
| | | menth- 1,3-dien-7-al. Other major |
| | | compounds present in cumin |
| | | contributing its distinct flavor include: |
| | | cuminal (8- 17%), β-pinene (22- |
| | | 27%), β-myrcene |
| | | (1.3-1.75%), ρ-cymene (23-39%), γ- |
| | | terpinene (11-27%), and ρ-mentha-1,4- |
| | | dien-7-ol (1.0-5.5%). |
| | | Coriander, Coriandrum sativum, has a |
| | | characteristic flavor is due to terpenes. |
| | | The essential oils present in oil glands |
| | | in the mericarp and the linalool, with |
| | | its floral and pleasant scents also |
| | | contribute to flavor enhancement. |
| | | Phenolics compounds present in the |
| | | coriander seeds such as gallic acid, |
| | | caffeic acid, ellagic acid, quercetin, |
| | | kaempferol contribute to the |
| | | antioxidant activity. |
| Thickener, | MC replacement | Pea fiber comprises insoluble fibers |
| Binding | system: | and higher protein content, which |
| agent, | Ingredients from | contribute to its ability to hold water. |
| Stabilizer | all five | The combination of protein and fiber |
| | categories | also leads to the higher oil absorbing |
| | (proteins; fibers | capacity. Peas comprise a high amylose |
| | from whole | starch content (25-29%) that enables it |
| | grains, fruits, | to bind water and oil. |
| | seeds and | Oat fibers retain water, decreases |
| | vegetables; | cooking loss, and it has a neutral |
| | starches; and | flavor. Oats comprise 4% (by weight) |
| | vegetable | of β- glucan, a soluble fiber with |
| | binders) and/or | potential binding abilities. Oat fiber |
| | any substitute(s) | provides flavor, texture, and mouthfeel |
| | that exhibit the | of fat. In addition, β-glucan also |
| | same or similar | comprises hydrocolloids that provide |
| | properties and | emulsion stability, modifying the |
| | functionalities | gelation process and increasing |
| | | viscosity. β- glucan forms a porous |
| | | network in a protein-gel matrix, e.g., |
| | | holding fat globules in the burger |
| | | system. |
| | | Chickpeas comprise starch and protein, |
| | | and act as binder and stabilizer. |
| | | Chickpea proteins include globulins |
| | | and albumin, which act as binding |
| | | proteins; these binding proteins |
| | | constitute 72-85% of the weight of the |
| | | chickpea, and function as thickeners |
| | | and binders by forming protein |
| | | matrices that hold water and fat. |
| | | Quinoa starch is relatively low (e.g., |
| | | 11%) in amylose and appears as small |
| | | granules (1 to 3 μm). Quinoa starch |
| | | has unique properties: low pasting |
| | | temperature, high freeze-thaw stability, |
| | | and water holding capacity. The |
| | | quinoa starch granules are small, |
| | | polygonal, and in the range of 0.5-3 |
| | | μm; they function as a stabilizer for |
| | | creating pickering emulsions. The |
| | | proteins from quinoa flour help |
| | | provide structure and shape to the food |
| | | product. |
| Hydro | Plant-only Gum | The main fraction of quince seed gum |
| Colloids- | replacement | are high-molecular-weight |
| gelling, | system(s) (One | polysaccharides, the most abundant |
| emulsifier, | or more of | among them which is d-Xylan, with |
| stabilizer, | quince seed | many glucuronic acid residues. The |
| sequestrant | mucilage, | presence of proteins in quince seed |
| | mesquite | gum (2.2%) affects the interfacial |
| | protein, almond | tension at the oil-water interface, and |
| | polysaccharides, | contributes to its ability to act as an |
| | and linseed | emulsifier. |
| | mucilate and/or | Almond is mainly composed of 92.36% |
| | substitute(s) that | of polysaccharides (dry weight basis) |
| | exhibit the same | with the major sugar composition |
| | or similar | comprising: arabinose (46.83%), |
| | properties and | galactose (35.49%) and uronic acid |
| | functionality) | (5.97%). It also comprises a small |
| | | amount of protein (2.45%). |
| | | Mesquite proteins are a complex |
| | | carbohydrate and protein mix and is |
| | | comprised of D-galactose, L- |
| | | arabinose, D-glucuronate, D-mannose |
| | | and D- xylose. |
| | | Apple pomace pectin is a low methyl |
| | | cellulose-containing pectin, it forms a |
| | | thermo-irreversible gel, remaining in a |
| | | gel consistency even at high |
| | | temperatures that would normally |
| | | melt pectin. Pectin's aid in the |
| | | formation of |
| | | smaller droplet size emulsions, |
| | | showing higher stability and forming a |
| | | gel-like consistency. The action of the |
| | | insoluble fibers in pectin maintain their |
| | | stability in emulsions through pickering |
| | | mechanism and through network |
| | | formation in the continuous phase; this |
| | | may be favored by stabilization of |
| | | proteins and pectin in the soluble |
| | | fraction. |
| Flavoring | Flavor enhancer, | Nutritional yeast is a food additive |
| agent | nutritional yeast | made from a single-celled organism, |
| | (one or more of | Saccharomyces cerevisiae, a member |
| | nutritional yeast, | of the fungi kingdom. This yeast is |
| | cashews and/or | grown on molasses and then harvested, |
| | any substitute(s) | washed, and dried with heat to kill or |
| | for either one | deactivate it. |
| | that exhibits the | Cashews comprises esters (methyl 3- |
| | same or similar | methyl butanoate, ethyl 3-methyl |
| | functionality and | butanoate, methyl butanoate, ethyl |
| | properties) | butanoate, ethyl trans-2-butenoate and |
| | | methyl 3-methyl pentanoate) which |
| | | impart a sweet, fruity taste and aroma. |
| Leavening | Leavener | Apple cider vinegar is the fermented |
| agent(s) | replacement system | juice of crushed apples, comprising |
| | (ingredients from | acetic acid, which contributes to the |
| | five categories, | leavening action in food products. |
| | including one or | Dried plums comprise about 2% |
| | more of plum | naturally occurring malic acid, which |
| | powder, apple | serves as the natural acid component of |
| | cider vinegar, | chemical leavening systems. Dried |
| | vegan buttermilk, | plums can also act as a natural |
| | and/or any | preservative, inhibiting microbial |
| | substitute(s) that | spoilage. |
| | exhibit the same | Vegan buttermilk is made by |
| | or similar | combining almond milk with |
| | functionality and | acidulants. The high fat content |
| | properties) | combined with acids result in |
| | | curdling. |
| Lipid | Lipid | Black pepper (P. nigrum) with piperine |
| peroxidation | peroxidation | as an active ingredient, holds rich |
| inhibitor, | inhibitors (one or | phytochemistry that also includes |
| antioxidant, | more of black | volatile oil, oleoresins, and alkaloids. |
| flavor | pepper, bay leaf, | Black pepper oleoresins impart taste |
| enhancer | cumin, and/or | and exhibit antioxidant properties. |
| | any substitute(s) | They are also used as a colorant and a |
| | that exhibit the | food preservative because of their |
| | same or similar | antimicrobial properties. β- |
| | functionality and | Caryophyllene, limonene, β-pinene, α- |
| | properties) | pinene, δ-3-carene, sabinene, and |
| | | myrcene are the main components of |
| | | this oil. |
| | | Bay leaves show radical scavenging |
| | | activity due to the presence of |
| | | sesquiterpene lactones, alkaloids, and |
| | | glycosylated flavonoids. The |
| | | kaempferol C-glycoside is the major |
| | | contributor to antioxidant properties. |
| | | Cumin's antioxidant activity is |
| | | correlated with the presence of high |
| | | polyphenols, mainly flavonoids. The |
| | | essential oils present - carvacrol, |
| | | anethole, and terpineol - also contribute |
| | | to the function of radical scavenging. |
| Color | One or more | Leghaemoglobin is a protein that binds |
| retention, | sources of | oxygen and is found in the root nodules |
| coloring | leghaemoglobin | of leguminous plants; it is often used as |
| agent, nitrite | (one or more of | an ingredient in some plant-based meat |
| replacement | bects, red | substitutes. |
| | radishes and/or | Red beet—B. vulgaris—is one of the |
| | any substitute(s) | top ten most potent antioxidant-rich |
| | that exhibit the | vegetables. Betalains (including |
| | same or similar | betanin/betanidin) exhibit high |
| | functionality and | antioxidant activity. Red radish and |
| | properties) | beet powders exhibit antioxidant |
| | | activity and are high in nitrates. Radish |
| | | powder in particular prevents meats |
| | | and meat substitutes from changing |
| | | color. |

Table 10 below, provides a preparation of the ingredient of the Plant-only composition/gum replacement system against each category.

TABLE 10
Preparation method of each of the ingredient of the Plant-only
composition/gum replacement system against each category:

| Ingredient | Preparation method |
|---|---|
| Almond | A grinder is used to grind the almonds. Fruit powder is |
| polysaccharides | added to a 1000 milliliter (ml) beaker with 500 ml of |
| | water, and the mixture is heated and stirred at 60° C. for 4 |
| | hours. The concentrated solution is refrigerated at 4° C.- |
| | 6° C. after being filtered through muslin cloth. By putting |
| | the gum into ethyl alcohol and filtering it through muslin |
| | cloth, the gum is isolated and precipitated. Gum is |
| | extracted of its oil, and then it is further dried to a |
| | consistent weight in a hot air oven at 35° C. to 45° C. |
| Quince seed | Clean quince seeds are combined with water. The |
| mucilage | amount of water to seed is predetermined to be 20:1 |
| | (v/w), and the mixture is agitated at 75° C. for 3 hours. |
| | Muslin cloth is used to separate the seeds from the |
| | water. Three times, 96% ethanol is used to precipitate |
| | the mucilage, and then the precipitates are separated by |
| | centrifuging at 6500 rpm for 15 minutes. The mucilage |
| | (10.9% yield) is subsequently dried for 4 hours in an |
| | oven at 70° C. |
| Mesquite protein | At moderate thermal conditions, not exceeding 40° C., the |
| | Soxhlet technique is employed to extract the mesquite |
| | protein concentrate. A 1:8 ratio of flour-water |
| | suspensions are added to the defatted flour. The pH is |
| | brought to 8 for the extraction of soluble carbohydrates, |
| | etc. These suspensions underwent a 30-minute |
| | centrifugation at 300 rpm and 40° C. The mixture is |
| | allowed to cool after the extraction period and is through |
| | in order to separate the supernatant from the residue. In a |
| | 50 ml beaker, the washed supernatants and the protein |
| | extract are combined. The extract is acidified with until |
| | pH 5.5, the point at which the majority of the proteins |
| | precipitate is attained. The protein extract is centrifuged |
| | after being shaken at 300 rpm for 30 minutes while |
| | being stored at 37° C. The proteins are then decanted. |
| | The solution is vacuum dried to obtain the protein |
| | coagulum. |
| Linseed mucilage | Flaxseeds/Linseeds are soaked in warm water with a |
| | water to seed ratio of 7:1 at 70° C. for 60 minutes. The |
| | separation of liquid fractions comprising mucilage from |
| | flax seeds is performed by 200 mesh cheesecloth. The |
| | pooling of fractions and concentration are carried out |
| | under reduced pressure. Mucilage is recovered after |
| | vacuum drying at 50° C. |

FIG. 2 illustrates a flow diagram of a process of preparing a plant-only composition for a food product according to some embodiments herein. At a step 202, dried powdered/ingredients of (A) about 20-40% weight by weight of almond polysaccharides and/or like any one or more of oat flour, etc., (B) about 10-20% weight by weight of a Quince seed mucilage and/or like any or more of sweet basil seeds mucilage, etc., (C) about 5-20% weight by weight of Mesquite protein and/or like any or more of peas, chickpea etc., and (D) about 5-20% weight by weight of Linseed mucilage and/or like any one or more of Plantago psyllium mucilage, etc. are mixed together. At a step 204, the mixture then undergoes a low order heat treatment to form a gel at a temperature of between 60° C. and 105° C. At a step 206, using a blender or a bowl cutter, all of the ingredients in the Plant-only composition/gum replacement system are incorporated with the whole formulation of the intended food product in a gel or dough.

While specific embodiments of the present disclosure have been shown and described in detail to illustrate the inventive principles, it will be understood that the present disclosure may be embodied otherwise without departing from such principles.

While considerable emphasis has been placed herein on the specific features of the preferred embodiment, it will be appreciated that many additional features can be added and that many changes can be made in the preferred embodiment without departing from the principles of the present disclosure. These and other changes in the preferred embodiment of the present disclosure will be apparent to those skilled in the art from the present disclosure herein, whereby it is to be distinctly understood that the foregoing descriptive matter is to be interpreted merely as illustrative of the present disclosure and not as a limitation.

The use of the expression “at least” or “at least one” suggests the use of one or more elements or components, as the use may be in the embodiment of the present disclosure to achieve one or more of the desired objects or results. While certain embodiments of the present disclosure have been described, these embodiments have been presented by way of example only, and are not intended to limit the scope of the present disclosure. Variations or modifications to the formulation of this present disclosure, within the scope of the present disclosure, may occur to those skilled in the art upon reviewing the present disclosure herein. Such variations or modifications are well within the spirit of this present disclosure.

Reference throughout this specification to “some embodiments”, “an embodiment”, or similar language means that a particular feature, structure, or characteristic described in connection with the embodiment is included in at least one embodiment of the present disclosure. Thus, appearances of the phrases “in some embodiments”, “in an embodiment” and similar language throughout this specification may, but do not necessarily, all refer to the same embodiment.

It should be understood that the figures shown above highlighting the functionality and advantages of the present disclosure are presented for example purposes only. The present disclosure is sufficiently flexible and configurable, such that it may be utilized in ways other than that shown in the figures.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A plant-only composition for a food product, comprising:
about 5% to about 60% weight by weight of one or more polysaccharides sources;
about 1% to about 30% weight by weight of one or more plant-derived mucilage;
about 1% to about 30% weight by weight of one or more plant-derived protein; and
about 1% to about 30% weight by weight of one or more plant-derived fiber mucilage, wherein the plant-only composition substitutes a gum ingredient in the food product.

2. The plant-only composition of claim 1, wherein the one or more polysaccharides sources comprises at least one of almond polysaccharides, oat flour, quinoa flour, cassava flour, sunflower seeds flour, palm kernel meal, coconut flour, soya bean hulls, sugar beet pulp, pecan flour, cashew flour, macadamia flour, or a combination thereof.

3. The plant-only composition of claim 2, wherein the almond polysaccharides comprises (i) about 92.36% of polysaccharides comprising about 46.83% of arabinose, about 35.49% of galactose, and 5.97% of uronic acid, and (ii) about 2.45% of protein, wherein the almond polysaccharides acts as a stabilizer, and an emulsifier in the food product as it stabilize the emulsion to form structured films.

4. The plant-only composition of claim 1, wherein the one or more polysaccharides sources present in the plant-only composition ranges from about 20% to about 40% weight by weight of the composition.

5. The plant-only composition of claim 1, wherein the one or more polysaccharides sources present in the plant-only composition ranges from (i) about 5% to about 10% weight by weight of the composition, (ii) about 10% to about 20% weight by weight of the composition, (iii) about 20% to about 30% weight by weight of the composition, (iv) about 30% to about 40% weight by weight of the composition, (v) about 40% to about 50% weight by weight of the composition, or (vi) about 50% to about 60% weight by weight of the composition.

6. The plant-only composition of claim 1, wherein the one or more polysaccharides sources has a polysaccharides content of about 20% to about 92.36%, a swelling index ranging from 22.27% to 87.75%, and an emulsion stability of about 45.83% to about 92.6%, a pH of about 3.9 to about 4.4, moisture content of about 12.5% to about 15.0%, bulk density of about 0.6 gram per milliliter (g/ml), and a porosity of about 42.06%.

7. The plant-only composition of claim 1, wherein the one or more plant-derived mucilage
comprises at least one of quince seed mucilage, sweet basil seed mucilage, chia seed mucilage, yellow mustard mucilage, moringa seeds mucilage, fenugreek seeds mucilage, Cordia dichotoma seeds mucilage, arugula seeds mucilage, radish seeds mucilage, cress seeds mucilage, okra mucilage, or a combination thereof.

8. The plant-only composition of claim 7, wherein the quince seed mucilage comprises glucuronic acid and xylose that forms glucuronoxylan polysaccharide hydrogel which has increased swelling power, wherein the quince seed mucilage comprises about 2.2% protein that affects the interfacial tension at the oil-water interface which directly affects its emulsification stability.

9. The plant-only composition of claim 1, wherein the one or more plant-derived mucilage
present in the plant-only composition ranges from about 10% to about 20% weight by weight of the composition.

10. The plant-only composition of claim 1, wherein the one or more plant-derived mucilage present in the plant-only composition ranges from (i) about 1% to about 5% 2 weight by weight of the composition, (ii) about 5% to about 10% weight by weight of the composition, (iii) about 5% to about 20% weight by weight of the composition, (iv) about 10% to about 15% weight by weight of the composition, (v) about 15% to about 20% weight by weight of the composition, (v) about 20% to about 25% weight by weight of the composition, or (vi) about 25% to about 30% weight by weight of the composition.

11. The plant-only composition of claim 1, wherein the one or more plant-derived mucilage has a viscosity of about 1000 millipascal seconds at a shear rate of 46.16 inverse
second (s⁻¹), a water holding capacity of about 10.27 grams water per gram (g/g) to about 94.13 g/g, an emulsion stability of about 35% to about 94.89%, a moisture content of about 5.8%, a viscosity of about 1473.96 millipascal seconds at shear rate of about 46.16 inverse second, a zeta potential measurement of greater than 30 millivolt (mV), and a foam stability of about 21.36%.

12. The plant-only composition of claim 1, wherein the one or more plant-derived protein comprises at least one of mesquite protein, pea protein, lupine, mushrooms, quinoa, chickpeas protein, soy protein, pigeon pea, mung bean protein, peanut, pinto beans, oats, cow pea protein, or a combination thereof.

13. The plant-only composition of claim 12, wherein the mesquite protein comprises about 68% of protein, D-galactose, L-arabinose, D-glucuronate, D-mannose and D-xylose, wherein the mesquite protein comprises galactomannans polysaccharide that act as a stabilizing and emulsifying agent in food products, wherein the mesquite protein enables the formation and stabilization of emulsions in the presence of polysaccharides and has a shear thickening behaviour.

14. The plant-only composition of claim 1, wherein the one or more plant-derived protein present in the plant-only composition ranges from about 5% to about 20% weight by weight of the composition.

15. The plant-only composition of claim 1, wherein the one or more plant-derived protein present in the plant-only composition ranges from (i) about 1% to about 5% weight by weight of the composition, (ii) about 5% to about 10% weight by weight of the composition, (iii) about 5% to about 20% weight by weight of the composition, (iv) about 10% to about 15% weight by weight of the composition, (v) about 15% to about 20% weight by weight of the composition, (vi) about 20% to about 25% weight by weight of the composition, or (v) about 25% to about 30% weight by weight of the composition.

16. The plant-only composition of claim 1, wherein the one or more plant-derived protein has a molecular weight of about 10 to 50 kilodaltons (kDa), a water holding capacity of about 100% to 600%, an emulsion stability of about 35% to about 90%, a pH of about 4.38, moisture content of about 9.7% to 10.2%, and a molecular weight of about 484,000 gram per molar (g/mol).

17. The plant-only composition of claim 1, wherein the one or more plant-derived fiber mucilage comprises at least one of linseed mucilage, Plantago psyllium mucilage, Plantago ovata seeds mucilage, chia seeds mucilage, mucilages of mangosteen, assyrian plum, prickly pear, cassava, Indian jujube fruit, coromandel ebony, orange fiber, tilkor fruit, or a combination thereof.

18. The plant-only composition of claim 17, wherein the linseed mucilage comprises fiber, omega-3 and -6 fatty acids, and phenolic compounds and has arabinoxylans, which are non-starch polysaccharides, wherein the linseed mucilage increases protein and fat content, and decreases moisture in raw meat burgers, and further reduces fat absorption in frying.

19. The plant-only composition of claim 1, wherein the one or more plant-derived fiber mucilage present in the plant-only composition ranges from about 5% to about 20% weight by weight of the composition.

20. The plant-only composition of claim 1, wherein the one or more plant-derived fiber mucilage present in the plant-only composition ranges from (i) about 1% to about 5% weight by weight of the composition, (ii) about 5% to about 10% weight by weight of the composition, (iii) about 5% to about 20% weight by weight of the composition, (iv) about 10% to about 15% weight by weight of the composition, (v) about 15% to about 20% weight by weight of the composition, (vi) about 20% to about 25% weight by weight of the composition, or (vii) about 25% to about 30% weight by weight of the composition.

21. The plant-only composition of claim 1, wherein the one or more plant-derived fiber mucilage has a water holding capacity of about 2.57 to about 28.66 grams water per gram (g water/g), an emulsion stability of about 42.22% to 70%, and a polyunsaturated fatty acids (PUFA)/saturated fatty acids (SFA) ratio of about 7.40.

22. The plant-only composition of claim 1, wherein the food product comprises processed
cheese, soups, pastry ices, soft viscous candies, fruit-based and membrane-coated items, burgers, burger mixes, cakes, chocolate bars, pancake mixes, Traditional Burger Products, a baked good, a plant-only burger products, or another food product.

23. The plant-only composition of claim 1, wherein the plant-only composition comprises
about 20% to about 40% weight by weight of one or more polysaccharides sources;
about 10% to about 20% weight by weight of one or more plant-derived mucilage;
about 5% to about 20% weight by weight of one or more plant-derived protein; and
about 5% to about 20% weight by weight of one or more plant-derived fiber mucilage, wherein the plant-only composition substitutes a gum ingredient in the food product.

24. The plant-only composition of claim 1, wherein the plant-only composition comprises
about 20% to about 40% weight by weight of almond polysaccharides;
about 10% to about 20% weight by weight of quince seed mucilage;
about 5% to about 20% weight by weight of mesquite protein; and
about 5% to about 20% weight by weight of linseed mucilage, wherein the plant-only composition substitutes a gum ingredient in the food product.

25. The plant-only composition of claim 1, wherein the plant-only composition present in the food product ranges from about 0.5% to 3% weight by weight of the food product.

26. The plant-only composition of claim 1, wherein the plant-only composition present in the food product ranges from about 0.05% to about 10% weight by weight of the food product depending on the moisture content of the plant-only composition and that of the final food product.

27. The plant-only composition of claim 1, wherein the plant-only composition present in the food product ranges from about 0.05% to about 25% weight by weight of the food product.

28. A food product, comprising:
about 10% to about 15% weight by weight a plant-only composition, wherein the plant-only composition comprises
about 20% to about 40% weight by weight of one or more polysaccharides sources;
about 10% to about 20% weight by weight of one or more plant-derived mucilage;
about 5% to about 20% weight by weight of one or more plant-derived protein; and
about 5% to about 20% weight by weight of one or more plant-derived fiber mucilage, wherein the plant-only composition substitutes a gum ingredient in the food product.

29. The food product as claimed in claim 28, wherein the food product comprises
about 10% to about 20% weight by weight of one or more protein sources;
about 5% to about 10% weight by weight of a plant-derived methyl cellulose replacement composition;
about 10% to about 15% weight by weight of one or more plant-derived modified starches;
about 10% to about 12% weight by weight of one or more plant-derived oils; and about 0.5% to about 1% weight by weight of a plant-derived leavener replacement composition.

30. The food product as claimed in claim 29, wherein the food product comprises
about 1% to about 2% weight by weight of one or more plant-derived shelf life extenders;
about 0.5% to about 2% weight by weight of a plant-derived umami flavor;
about 0.5% to about 1% weight by weight of one or more plant-derived flavorants/flavor enhancers, or nutraceuticals;
about 1% to about 2% weight by weight of a second plant-derived flavor enhancer;
about 0.5% to about 2% weight by weight of one or more mineral salts;
about 5% to about 10% weight by weight of one or more plant-derived binding agents;
about 1% to about 2% weight by weight of one or more plant-derived leghemoglobin sources; and
about 0.5% to about 2% weight by weight of one or more plant-derived lipid peroxidation inhibitors.

31. The food product of claim 29, wherein the one or more protein sources comprises at least one of pea, mushroom, quinoa, chickpeas, or a combination thereof.

32. The food product of claim 29, wherein the plant-derived methyl cellulose replacement composition comprises at least one of proteins, fibers from whole grains, fruits, seeds, vegetables, starches, vegetable binders, or a combination thereof.

33. The food product of claim 29, wherein the one or more plant-derived oils comprises at least one of sunflower oil, coconut oil, flaxseed oil, rice bran oil, other oil comprising at least one of Omega-3 fatty acids, Monounsaturated fatty acids (MUFA), or Medium-chain triglycerides (MCTs), or a combination thereof.

34. The food product of claim 29, wherein the one or more plant-derived modified starches comprises at least one of tapioca starch, faba bean starch, sorghum starch, quinoa
starch, or a combination thereof.

35. The food product of claim 29, wherein the plant-derived leavener replacement composition comprises at least one of plant-derived fibers, fruit pectins, fruit acids, plant-derived starches, cereal sources, or a combination thereof.

36. The food product of claim 29, wherein the plant-derived leavener replacement composition comprises at least one of plum powder, apple cider vinegar, vegan buttermilk, or a combination thereof.

37. The food product of claim 30, wherein the one or more plant-derived shelf life extenders comprises at least one of garlic, black pepper, oregano, bay laurel, or a combination thereof, wherein the plant-derived umami flavor comprises at least one of shitake and other mushrooms, tomatoes, garlic, lotus stalk, onions, salt, or a combination thereof, wherein the one or more plant-derived flavorants/flavor enhancers, or nutraceuticals comprises at least one of cumin, coriander, paprika, black pepper, or a combination thereof, wherein the plant-derived enhancer comprises at least one of nutritional yeast, cashew nuts, or a combination thereof, wherein the one or more mineral salts comprises at least one of Himalayan pink salt, sea salt, or a combination thereof, wherein the one or more plant-derived binding agents comprises at least one of chickpeas,
oat fiber, aquafaba, sugar beet pectin, or a combination thereof, wherein the one or more plant-derived leghemoglobin sources comprises at least one of beets, soy, red radish, or a combination thereof, wherein the one or more plant-derived lipid peroxidation inhibitors comprises at least one of black pepper, bay leaf, cumin, or a combination thereof.

38. A plant-only gum replacement system for a food product comprising a plant-only composition, wherein said plant-only composition comprises:
about 5% to about 60% weight by weight of one or more polysaccharides sources;
about 1% to about 30% weight by weight of one or more plant-derived mucilage;
about 1% to about 30% weight by weight of one or more plant-derived protein; and
about 1% to about 30% weight by weight of one or more plant-derived fiber mucilage, wherein the plant-only composition substitutes a gum ingredient in the food product.
